(19) United States
(12) Patent Application Publication
(10) Pub. No.: US 2017/0073460 A1
(43) Pub. Date: Mar. 16, 2017

(54) POLYETHER KETONE COMPOUND

(71) Applicant: Ajinomoto Co., Inc., Tokyo (JP)

(72) Inventors: Fumi OGATA, Kawasakii-shi (JP); Ryotaro Nakaky, Kawasaki-shi (JP)

(73) Assignee: Ajinomoto Co., Inc., Tokyo (JP)

(21) Appl. No.: 15/360,194

(22) Filed: Nov. 23, 2016

Related U.S. Application Data
(63) Continuation of application No. PCT/JP2015/065140, filed on May 26, 2015.

(30) Foreign Application Priority Data
May 28, 2014 (JP) 2014-110498

(51) Int. Cl. C08G 61/12

(52) U.S. Cl. CPC C08G 61/127; C08G 2261/3442; C08G 2261/3245; C08G 2261/12

(57) ABSTRACT

Polyether ketone compounds obtained by reacting a compound represented by formula (1):

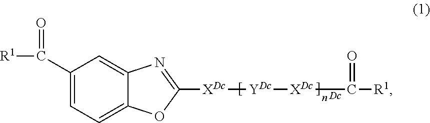

wherein R¹, X^{D}, Y^{Dc}, and n^{Dc} are defined herein,
with a compound represented by formula (2):

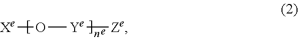

wherein X^{e}, Y^{e}, Z^{e}, and n^{e} are defined herein, exhibit high thermal resistance.

### CROSS REFERENCES TO RELATED APPLICATIONS

This application is a continuation of International Patent Application No. PCT/JP2015/065140, filed on May 26, 2015, and claims priority to Japanese Patent Application No. 2014-110498, filed on May 28, 2014, both of which are incorporated herein by reference in their entireties.

### BACKGROUND OF THE INVENTION

Field of the Invention

The present invention relates to a polyether ketone compounds.

Discussion of the Background

Polyether ketone compounds, such as a polyether ether ketone compound containing a structural unit represented by the formula below:

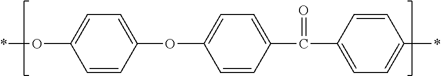

(in the formula, * represents a bond)
are used as engineering plastics because they have high thermal resistance and excellent strength (see, for example, U.S. Pat. No. 4,320,224, which is incorporated herein by reference in its entirety). Engineering plastics are used in technical fields such as automobiles and aircrafts, electrics and electronics, and machines, and their range of applicability is enlarged.

As the range of applicability of engineering plastics is enlarged, the usage environment thereof becomes increasingly severe. Polyether ketone compounds with higher thermal resistance are thus in demand.

### SUMMARY OF THE INVENTION

Accordingly, it is one object of the present invention to provide novel polyether ketone compounds with high thermal resistance.

These and other objects, which will become apparent during the following detailed description, have been achieved by the inventors' discovery that polyether ketone compounds obtained by reaction of a dicarboxylic acid compound having a particular structure with an ether compound having a particular structure exhibit high thermal resistance.

Specifically, the present invention provides the following embodiments:

(1) A polyether ketone compound obtained by reacting a compound represented by formula (1) below:

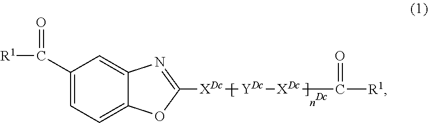

wherein:

R¹ represents a hydroxy group or a halogen atom;

X^{Dc} represents a divalent aromatic group optionally having a substituent, a divalent aliphatic hydrocarbon group optionally having a substituent, or a divalent non-aromatic heterocyclic group optionally having a substituent;

Y^{Dc} represents —O—, —N═N—, a carbonyl group, an alkenylene group optionally having a substituent, or a single bond;

n^{Dc} represents an integer of 0 to 2;

the two R¹ may be the same as or different from each other;

when there are a plurality of X^{Dc}, they may be the same as or different from each other; and

when there are a plurality of Y^{Dc}, they may be the same as or different from each other,

with a compound represented by formula (2) below:

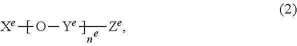

wherein:

X^{e} represents a monovalent aromatic hydrocarbon group optionally having a substituent;

Y^{e} represents a single bond, a divalent aliphatic hydrocarbon group optionally having a substituent, a divalent aromatic group optionally having a substituent, or a divalent non-aromatic heterocyclic group optionally having a substituent;

Z^{e} represents a monovalent aromatic hydrocarbon group optionally having a substituent;

n^{e} represents an integer of 1 to 5; and

when there are a plurality of Y^{e}, they may be the same as or different from each other.

(2) The polyether ketone compound according to (1), wherein X^{Dc} is a phenylene group optionally having a substituent, a naphthylene group optionally having a substituent, an anthracenylene group optionally having a substituent, a furandiyl group optionally having a substituent, a pyridinediyl group optionally having a substituent, a thiophenediyl group optionally having a substituent, a quinolinediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group containing an oxygen atom as a heteroatom composing a heterocycle and optionally having a substituent.

(3) The polyether ketone compound according to (1) or (2), wherein each of X^{e} and Z^{e} is individually a phenyl group optionally having a substituent or a naphthyl group optionally having a substituent.

(4) The polyether ketone compound according to any one of (1) to (3), wherein Y^{e} is a single bond, an alkylene group optionally having a substituent, a cycloalkylene group optionally having a substituent, a phenylene group optionally having a substituent, a naphthylene group optionally having a substituent, a furandiyl group optionally having a substituent, a pyridinediyl group optionally having a substituent, a thiophenediyl group optionally having a substituent, a quinolinediyl group optionally having a substituent, or a divalent non-aromatic heterocyclic group containing one or more atoms selected from the group consisting of an oxygen atom, a sulfur atom and a nitrogen atom as a heteroatom composing a heterocycle and optionally having a substituent.

(5) The polyether ketone compound according to any one of (1) to (4), wherein n^{Dc} is 0, and X^{Dc} is a phenylene group optionally having a substituent.

(6) The polyether ketone compound according to any one of (1) to (5), wherein, n^{e} is 1 or 2, each of X^{e} and Z^{e} is a phenyl group optionally having a substituent, and Y^{e} is a single bond or an alkylene group having 1 to 6 carbon atoms and optionally having a substituent.

(7) The polyether ketone compound according to any one of (1) to (6), wherein the substituent is selected from the group consisting of a halogen atom, an alkyl group, an alkoxy group, an aryl group, an alkylidene group, an amino group, a phosphino group, a formyl group, an acyl group, a cyano group, a nitro group, a hydroxy group, and an oxo group.

(8) The polyether ketone compound according to any one of (1) to (5), wherein the compound represented by formula (2) is one or more selected from the group consisting of compounds represented by formulae (2-1) to (2-19) below:

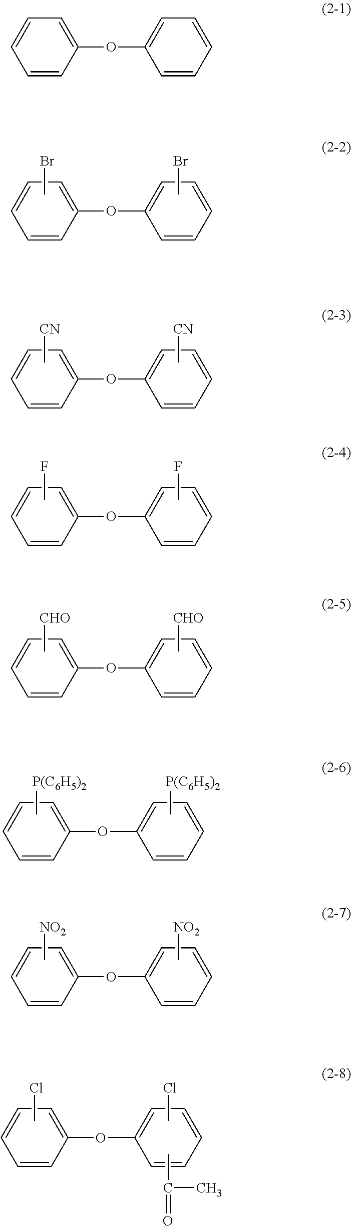

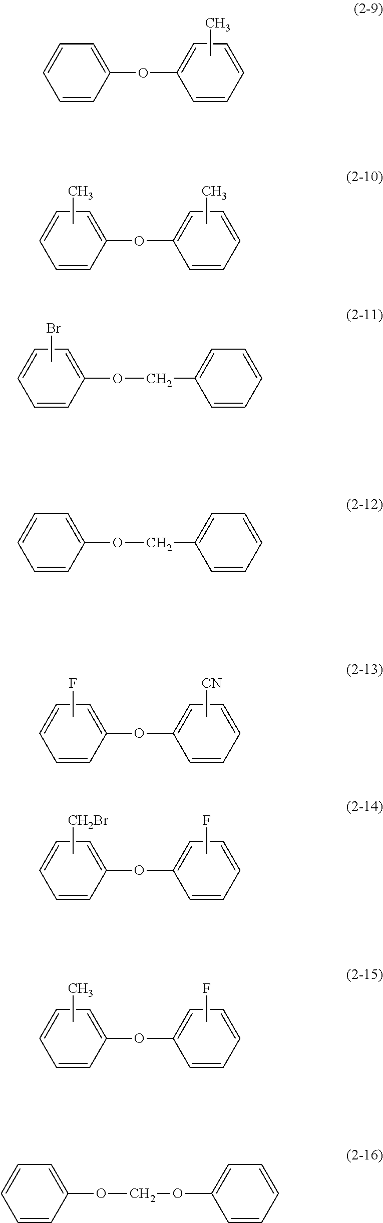

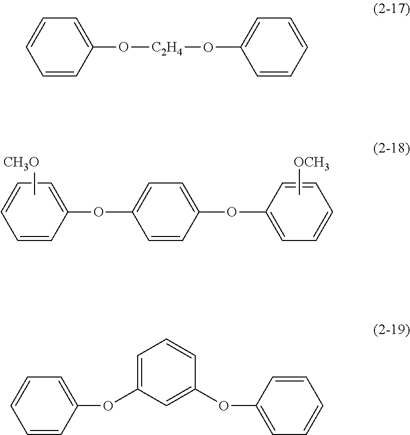

(9) The polyether ketone compound according to (8), wherein the compound represented by formula (2) is a compound represented by formula (2-1), (2-9), or (2-17).

(10) The polyether ketone compound according to any one of (1) to (9), wherein the polyether ketone compound is obtained by reacting a compound represented by formula (1), a compound represented by the formula (2), and one or more components selected from the group consisting of an aromatic dicarboxylic acid, a salt of an aromatic dicarboxylic acid, an ester of an aromatic dicarboxylic acid, and a halide of an aromatic dicarboxylic acid.

(11) The polyether ketone compound according to any one of (1) to (10), wherein the polyether ketone compound is obtained by a reaction of a compound represented by formula (1) and a compound represented by the formula (2) in a molar ratio of (the compound represented by formula (1))/(the compound represented by formula (2)) of 10/1 to 1/10.

(12) The polyether ketone compound according to any one of (1) to (11), wherein the polyether ketone compound is obtained by a reaction at a temperature of −10 to 200° C.

(13) A polyether ketone compound, comprising one or more structural units selected from the group consisting of structural units represented by formulae (i) to (iv):

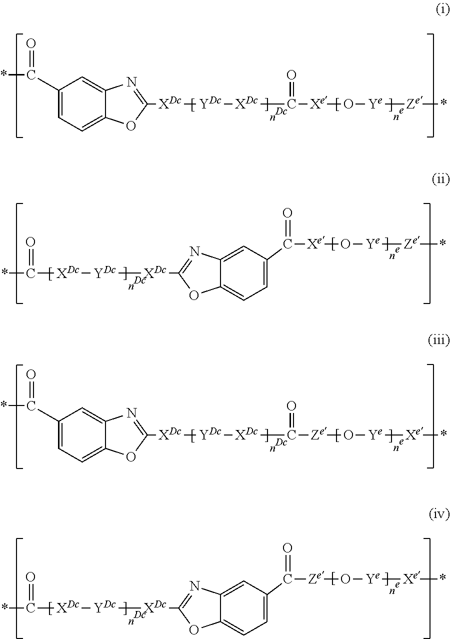

wherein:

X^{Dc} represents a divalent aromatic group optionally having a substituent, a divalent aliphatic hydrocarbon group optionally having a substituent, or a divalent non-aromatic heterocyclic group optionally having a substituent;

Y^{Dc} represents —O—, —N═N—, a carbonyl group, an alkenylene group optionally having a substituent, or a single bond;

n^{Dc} represents an integer of 0 to 2;

X^{e′} represents a divalent aromatic hydrocarbon group optionally having a substituent;

Y^{e} represents a single bond, a divalent aliphatic hydrocarbon group optionally having a substituent, a divalent aromatic group optionally having a substituent, or a divalent non-aromatic heterocyclic group optionally having a substituent;

Z^{e′} represents a divalent aromatic hydrocarbon group optionally having a substituent;

n^{e} represents an integer of 1 to 5, and

* represents a bond;

when there are a plurality of X^{Dc}, they may be the same as or different from each other;

when there are a plurality of Y^{e}, they may be the same as or different from each other; and

when there are a plurality of Y^{e}, they may be the same as or different from each other.

(14) The polyether ketone compound according to (13), which has a glass transition temperature (T_{g}) of 140° C. or higher and 400° C. or lower.

(15) The polyether ketone compound according to (13) or (14), which has a melting point (Tₘ) of 300° C. or higher and 500° C. or lower.

(16) The polyether ketone compound according to any one of (13) to (15), which has a 5% mass reduction temperature (T_{d}) of 300° C. or higher and 500° C. or lower.

(17) A method of producing a polyether ketone compound, the method comprising reacting a compound represented by formula (1):

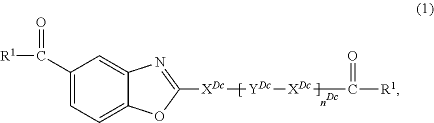

wherein:

R¹ represents a hydroxy group or a halogen atom;

X^{Dc} represents a divalent aromatic group optionally having a substituent, a divalent aliphatic hydrocarbon group optionally having a substituent, or a divalent non-aromatic heterocyclic group optionally having a substituent;

Y^{Dc} represents —O—, —N═N—, a carbonyl group, an alkenylene group optionally having a substituent, or a single bond;

n^{Dc} represents an integer of 0 to 2;

the two R¹ may be the same as or different from each other;

when there are a plurality of X^{Dc}, they may be the same as or different from each other; and

when there are a plurality of Y^{Dc}, they may be the same as or different from each other,

with a compound represented by formula (2):

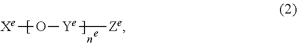

wherein:

X^{e} represents a monovalent aromatic hydrocarbon group optionally having a substituent;

Y^{e} represents a single bond, a divalent aliphatic hydrocarbon group optionally having a substituent, a divalent aromatic group optionally having a substituent, or a divalent non-aromatic heterocyclic group optionally having a substituent;

Z^{e} represents a monovalent aromatic hydrocarbon group optionally having a substituent;

n^{e} represents an integer of 1 to 5; and

when there are a plurality of Y^{e}, they may be the same as or different from each other,

at a molar ratio of (the compound represented by formula (1))/(the compound represented by formula (2)) of 1/10 to 10/1.

The present invention provides novel polyether ketone compounds with high thermal resistance.

### DETAILED DESCRIPTION OF THE PREFERRED EMBODIMENTS

### Explanation of Terms

In the present description, a “divalent aromatic group” refers to a group in which two hydrogen atoms are removed from an aromatic ring of an aromatic compound, and includes an arylene group and a heteroarylene group. Note that the heteroarylene group refers to a group in which two hydrogen atoms are removed from a heterocycle of an aromatic heterocyclic compound. The heterocycle means a ring containing not only a carbon atom, but also a heteroatom such as an oxygen atom, a sulfur atom, a nitrogen atom, a phosphorus atom, a boron atom, and a silicon atom, as an atom composing the ring.

In the present description, “a divalent non-aromatic heterocyclic group” refers to a group in which two hydrogen atoms are removed from a heterocycle of a non-aromatic heterocyclic compound.

In the present description, the term “Cₚ-C_{q}” (p and q are positive integers and satisfy p<q) denotes that the number of carbon atoms in the organic group described immediately after this term is p to q. For example, a “C₁-C₁₂ alkyl group” denotes an alkyl group having 1 to 12 carbon atoms, and a “C₁-C₁₂ alkyl ester” refers to an ester with an alkyl group having 1 to 12 carbon atoms.

In the present description, the term “optionally having a substituent” immediately following a compound or a group refers to both the case where a hydrogen atom of the compound or the group is not substituted with a substituent and the case where some or all of the hydrogen atoms of the compound or the group are replaced with substituents.

In the present description, the term “substituent” means a halogen atom, an alkyl group, a cycloalkyl group, an alkoxy group, a cycloalkyloxy group, an aryl group, an aryloxy group, an arylalkyl group, an arylalkoxy group, a monovalent heterocyclic group, an alkylidene group, an amino group, a silyl group, a phosphino group, a mercapto group, a formyl group, an acyl group, an acyloxy group, a carboxy group, a cyano group, a nitro group, a hydroxy group, and an oxo group, unless otherwise specified.

Examples of the halogen atom used as a substituent include a fluorine atom, a chlorine atom, a bromine atom, and an iodine atom.

The alkyl group used as a substituent may be either linear or branched. The number of carbon atoms of the alkyl group is preferably 1 to 20, more preferably 1 to 14, further preferably 1 to 12, even more preferably 1 to 6, and particularly preferably 1 to 3. Examples of the alkyl group include a methyl group, an ethyl group, a propyl group, an isopropyl group, a butyl group, a sec-butyl group, an isobutyl group, a tert-butyl group, a pentyl group, a hexyl group, a heptyl group, an octyl group, a nonyl group, and a decyl group. As will be described later, the alkyl group used as a substituent may further have a substituent (“additional substituent”). Examples of the alkyl group having such an additional substituent include an alkyl group substituted with a halogen atom, specifically, a monochloromethyl group, a dichloromethyl group, a trifluoromethyl group, a monobromomethyl group, a dibromomethyl group, and a tribromomethyl group.

The number of carbon atoms of the cycloalkyl group used as a substituent is preferably 3 to 20, more preferably 3 to 12, and further preferably 3 to 6. Examples of the cycloalkyl group include a cyclopropyl group, a cyclobutyl group, a cyclopentyl group, and a cyclohexyl group.

The alkoxy group used as a substituent may be either linear or branched. The number of carbon atoms of the alkoxy group is preferably 1 to 20, more preferably 1 to 12, and further preferably 1 to 6. Examples of the alkoxy group include a methoxy group, an ethoxy group, a propyloxy group, an isopropyloxy group, a butoxy group, a sec-butoxy group, an isobutoxy group, a tert-butoxy group, a pentyloxy group, a hexyloxy group, a heptyloxy group, an octyloxy group, a nonyloxy group, and a decyloxy group.

The number of carbon atoms of the cycloalkyloxy group used as a substituent is preferably 3 to 20, more preferably 3 to 12, and further preferably 3 to 6. Examples of the cycloalkyloxy group include a cyclopropyloxy group, a cyclobutyloxy group, a cyclopentyloxy group, and a cyclohexyloxy group.

The aryl group used as a substituent is a group in which one hydrogen atom is removed from an aromatic ring of an aromatic hydrocarbon. The number of carbon atoms of the aryl group used as a substituent is preferably 6 to 24, more preferably 6 to 18, further preferably 6 to 14, and even more preferably 6 to 10. Examples of the aryl group include a phenyl group, a naphthyl group, and an anthracenyl group.

The number of carbon atoms of the aryloxy group used as a substituent is preferably 6 to 24, more preferably 6 to 18, further preferably 6 to 14, and even more preferably 6 to 10. Examples of the aryloxy group used as a substituent include a phenoxy group, a 1-naphthyloxy group, and a 2-naphthyloxy group.

The number of carbon atoms of the arylalkyl group used as a substituent is preferably 7 to 25, more preferably 7 to 19, further preferably 7 to 15, and even more preferably 7 to 11. Examples of the arylalkyl group include a phenyl-C₁-C₁₂ alkyl group, a naphthyl-C₁-C₁₂ alkyl group, and an anthracenyl-C₁-C₁₂ alkyl group.

The number of carbon atoms of the arylalkoxy group used as a substituent is preferably 7 to 25, more preferably 7 to 19, further preferably 7 to 15, and even more preferably 7 to 11. Examples of the arylalkoxy group include a phenyl-C₁-C₁₂ alkoxy group and a naphthyl-C₁-C₁₂ alkoxy group.

The monovalent heterocyclic group used as a substituent refers to a group in which one hydrogen atom is removed from a heterocycle of a heterocyclic compound. The number of carbon atoms of the monovalent heterocyclic group is preferably 3 to 21, more preferably 3 to 15, and further preferably 3 to 9. A monovalent aromatic heterocyclic group (heteroaryl group) is also included in the monovalent heterocyclic group. Examples of the monovalent heterocycle include a thienyl group, a pyrrolyl group, a furyl group, a pyridyl group, a pyridazinyl group, a pyrimidyl group, a pyrazinyl group, a triazinyl group, a pyrrolidyl group, a piperidyl group, a quinolyl group, and an isoquinolyl group.

The alkylidene group used as a substituent refers to a group in which two hydrogen atoms are removed from the same carbon atom of an alkane. The number of carbon atoms of the alkylidene group is preferably 1 to 20, more preferably 1 to 14, further preferably 1 to 12, even more preferably 1 to 6, and particularly preferably 1 to 3. Examples of the alkylidene group include a methylidene group, an ethylidene group, a propylidene group, an isopropylidene group, a butylidene group, a sec-butylidene group, an isobutylidene group, a tert-butylidene group, a pentylidene group, a hexylidene group, a heptylidene group, an octylidene group, a nonylidene group, and a decylidene group.

Each of the amino group, silyl group, phosphino group, and mercapto group used as a substituent refers to a group represented by formula —NH₂, a group represented by formula —SiH₃, a group represented by formula —PH₂, and a group represented by formula —SH, respectively. As will be described later, each of these groups may further have a substituent (“additional substituent”). Examples of the phosphino group having an additional substituent include a monoalkyl phosphino group, a dialkyl phosphino group, a monoaryl phosphino group, and a diaryl phosphino group; and specifically, a monomethyl phosphino group, a dimethyl phosphino group, a monophenyl phosphino group, and a diphenyl phosphino group.

The acyl group used as a substituent refers to a group represented by formula —C(═O)—R (where R is an alkyl group or an aryl group). The alkyl group represented by R may be either linear or branched. Examples of the aryl group represented by R include a phenyl group, a naphthyl group, and an anthracenyl group. The number of carbon atoms of the acyl group is preferably 2 to 20, more preferably 2 to 13, and further preferably 2 to 7. Examples of the acyl group include an acetyl group, a propionyl group, a butyryl group, an isobutyryl group, a pivaloyl group, and a benzoyl group.

The acyloxy group used as a substituent refers to a group represented by formula —O—C(═O)—R (where R is an alkyl group or an aryl group). The alkyl group represented by R may be either linear or branched. Examples of the aryl group represented by R include a phenyl group, a naphthyl group, and an anthracenyl group. The number of carbon atoms of the acyloxy group is preferably 2 to 20, more preferably 2 to 13, and further preferably 2 to 7. Examples of the acyloxy group include an acetoxy group, a propionyloxy group, a butyryloxy group, an isobutyryloxy group, a pivaloyloxy group, and a benzoyloxy group.

The substituent as described above may further have a substituent (it may be referred to as “additional substituent”). The same substituent as described above may be used as the additional substituent, unless otherwise specified.

The present invention will be described in detail below with reference to preferable embodiments thereof.

### Polyether Ketone Compound

The polyether ketone compound of the present invention is obtained by reacting a compound represented by formula (1):

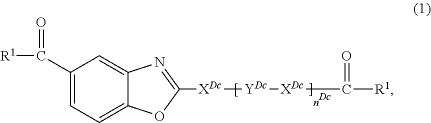

wherein:

R¹ represents a hydroxy group or a halogen atom;

X^{Dc} represents a divalent aromatic group optionally having a substituent, a divalent aliphatic hydrocarbon group optionally having a substituent, or a divalent non-aromatic heterocyclic group optionally having a substituent;

Y^{Dc} represents —O—, —N═N—, a carbonyl group, an alkenylene group optionally having a substituent, or a single bond;

n^{Dc} represents an integer of 0 to 2;

the two R¹ may be the same as or different from each other;

when there are a plurality of X^{Dc}, they may be the same as or different from each other; and

when there are a plurality of Y^{Dc}, they may be the same as or different from each other,

with a compound represented by formula (2) below:

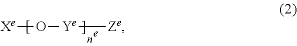

wherein:

X^{e} represents a monovalent aromatic hydrocarbon group optionally having a substituent;

Y^{e} represents a single bond, a divalent aliphatic hydrocarbon group optionally having a substituent, a divalent aromatic group optionally having a substituent, or a divalent non-aromatic heterocyclic group optionally having a substituent;

Z^{e} represents a monovalent aromatic hydrocarbon group optionally having a substituent;

n^{e} represents an integer of 1 to 5; and

1 when there are a plurality of Y^{e}, they may be the same as or different from each other.

In the formula (1), R¹ represents a hydroxy group or a halogen atom. The two R¹ may be the same as or different from each other.

Examples of the halogen atom represented by R¹ include a fluorine atom, a chlorine atom, a bromine atom, and an iodine atom. A chlorine atom is preferable.

In the formula (1), X^{Dc} represents a divalent aromatic group optionally having a substituent, a divalent aliphatic hydrocarbon group optionally having a substituent, or a divalent non-aromatic heterocyclic group optionally having a substituent.

Examples of the divalent aromatic group in X^{Dc} include an arylene group and a heteroarylene group. An arylene group having 6 to 24 carbon atoms and a heteroarylene group having 3 to 21 carbon atoms are preferable. An arylene group having 6 to 18 carbon atoms and a heteroarylene group having 3 to 15 carbon atoms are more preferable. An arylene group having 6 to 14 carbon atoms and a heteroarylene group having 3 to 9 carbon atoms are further preferable. An arylene group having 6 to 10 carbon atoms and a heteroarylene group having 3 to 6 carbon atoms are even more preferable. The number of carbon atoms described above does not include the number of carbon atoms of the substituent.

Specific examples of the divalent aromatic group in X^{Dc} include a phenylene group, a naphthylene group, an anthracenylene group, a pyrenediyl group, a pyrrolediyl group, a furandiyl group, a thiophenediyl group, a pyridinediyl group, a pyridazinediyl group, a pyrimidinediyl group, a pyrazinediyl group, a triazinediyl group, a pyrrolinediyl group, a piperidinediyl group, a triazolediyl group, a purinediyl group, an anthraquinonediyl group, a carbazolediyl group, a fluorenediyl group, a quinolinediyl group, and an isoquinolinediyl group.

In view of obtaining a polyether ketone compound with high thermal resistance, the divalent aromatic group in X^{Dc} is preferably an arylene group having 6 to 14 carbon atoms or a heteroarylene group having 3 to 9 carbon atoms, more preferably a phenylene group, a naphthylene group, an anthracenylene group, a furandiyl group, a pyridinediyl group, a thiophenediyl group, or a quinolinediyl group, and further preferably a phenylene group or a naphthylene group.

The divalent aliphatic hydrocarbon group in X^{Dc} may be either a saturated hydrocarbon group or an unsaturated hydrocarbon group. The number of carbon atoms thereof is preferably 1 to 60, more preferably 1 to 40, further preferably 1 to 30, even more preferably 1 to 20, and particularly preferably 1 to 10 or 1 to 6. The number of carbon atoms described above does not include the number of carbon atoms of the substituent.

Examples of the divalent aliphatic hydrocarbon group in X^{Dc} include an alkylene group, a cycloalkylene group, an alkenylene group, a cycloalkenylene group, an alkynylene group, a cycloalkynylene group, an alkapolyenylene group (the number of double bonds is preferably 2 to 10, more preferably 2 to 6, further preferably 2 to 4, and even more preferably 2), an alkadiynylene group, and an alkatriynylene group. The divalent aliphatic hydrocarbon group in X^{Dc} is preferably an alkylene group, a cycloalkylene group, an alkenylene group, a cycloalkenylene group, or an alkynylene group; more preferably an alkylene group or a cycloalkylene group; and further preferably a cycloalkylene group.

The number of carbon atoms of an alkylene group in X^{Dc} is preferably 1 to 60, more preferably 1 to 40, further preferably 1 to 30, even more preferably 1 to 20, and particularly preferably 1 to 15, 1 to 12, 1 to 9, 1 to 6, or 1 to 4. The number of carbon atoms described above does not include the number of carbon atoms of the substituent. Examples of the alkylene group include a methylene group, an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, an octadecylene group, a nonadecylene group, and an icocylene group.

The number of carbon atoms of a cycloalkylene group in X^{Dc} is preferably 3 to 10, and more preferably 3 to 6. The number of carbon atoms described above does not include the number of carbon atoms of the substituent. Examples of the cycloalkylene group include a cyclopropylene group, a cyclobutylene group, a cyclopentylene group, a cyclohexylene group, a decahydronaphthanylene group, a norbornanylene group, and an adamantanylene group.

The number of carbon atoms of an alkenylene group in X^{Dc} is preferably 2 to 60, more preferably 2 to 40, further preferably 2 to 30, even more preferably 2 to 20, and particularly preferably 2 to 10, 2 to 6, or 2 to 3. The number of carbon atoms described above does not include the number of carbon atoms of the substituent. Examples of the alkenylene group include an ethenylene group, a propenylene group, a butenylene group, a pentenylene group, a hexenylene group, a heptenylene group, an octenylene group, a nonenylene group, a decenylene group, an undecenylene group, a dodecenylene group, a tridecenylene group, a tetradecenylene group, a pentadecenylene group, a hexadecenylene group, a heptadecenylene group, an octadecenylene group, a nonadecenylene group, and an icocenylene group.

The number of carbon atoms of a cycloalkenylene group in X^{Dc} is preferably 3 to 10, and more preferably 3 to 6. The number of carbon atoms described above does not include the number of carbon atoms of the substituent. Examples of the cycloalkenylene group include a cyclopropenylene group, a cyclobutenylene group, a cyclopentenylene group, a cyclohexenylene group, and a norbornenylene group.

The number of carbon atoms of an alkynylene group in X^{Dc} is preferably 2 to 60, more preferably 2 to 40, further preferably 2 to 30, even more preferably 2 to 20, and particularly preferably 2 to 10, 2 to 6, or 2 to 3. The number of carbon atoms described above does not include the number of carbon atoms of the substituent. Examples of the alkynylene group include an ethynylene group, a propynylene group, a butynylene group, a pentynylene group, a hexynylene group, a heptynylene group, and an octynylene group.

The number of carbon atoms of a divalent non-aromatic heterocyclic group in X^{Dc} is preferably 2 to 21, more preferably 2 to 15, further preferably 2 to 9, even more preferably 2 to 6, and particularly preferably 2 to 5. The number of carbon atoms described above does not include the number of carbon atoms of the substituent. The divalent non-aromatic heterocyclic group of X^{Dc} contains preferably one or more atoms selected from the group consisting of an oxygen atom, a sulfur atom, a nitrogen atom, a phosphorus atom, a boron atom, and a silicon atom; and more preferably one or more atoms selected from the group consisting of an oxygen atom, a sulfur atom, and nitrogen atom; as a heteroatom composing a heterocycle.

Specific examples of the divalent non-aromatic heterocyclic group in X^{Dc} include an oxiranediyl group, an aziridinediyl group, an azetidinediyl group, an oxetanediyl group, a thietanediyl group, a pyrrolidinediyl group, a dihydrofurandiyl group, a tetrahydrofurandiyl group, a dioxolanediyl group, a tetrahydrothiophenediyl group, an imidazolidinediyl group, an oxazolidinediyl group, a piperidinediyl group, a dihydropyrandiyl group, a tetrahydropyrandiyl group, a tetrahydrothiopyrandiyl group, a morpholinediyl group, a thiomorpholinediyl group, a piperazinediyl group, a dihydrooxazinediyl group, a tetrahydrooxazinediyl group, a dihydropyrimidinediyl group, a tetrahydropyrimidinediyl group, and an exo-3,6-epoxy-1,2,3,6-tetrahydrophenylene group. Among them, in view of obtaining a polyether ketone compound with high thermal resistance, the divalent non-aromatic heterocyclic group in X^{Dc} is preferably a divalent non-aromatic heterocyclic group containing an oxygen atom as a heteroatom composing a heterocycle; more preferably an oxiranediyl group, an oxetanediyl group, a dihydrofurandiyl group, a tetrahydrofurandiyl group, a dioxolanediyl group, an oxazolidinediyl group, a dihydropyrandiyl group, a tetrahydropyrandiyl group, a morpholinediyl group, a dihydrooxazinediyl group, a tetrahydrooxazinediyl group, and an exo-3,6-epoxy-1,2,3,6-tetrahydrophenylene group; and further preferably an oxiranediyl group, a dioxolanediyl group, a tetrahydropyrandiyl group, and an exo-3,6-epoxy-1,2,3,6-tetrahydrophenylene group.

The substituent that the divalent group in X^{Dc} may have is as previously mentioned. When the divalent group in X^{Dc} has a plurality of substituents, they may be the same as or different from each other. Among them, the substituent that the divalent group in X^{Dc} may have is preferably one or more groups selected from the group consisting of a halogen atom, an alkyl group, an alkoxy group, an aryl group, an alkylidene group, an amino group, a phosphino group, a formyl group, an acyl group, a cyano group, a nitro group, a hydroxy group, and an oxo group; more preferably one or more groups selected from the group consisting of a halogen atom, an alkyl group, an aryl group, an alkylidene group, an amino group, a hydroxy group, and an oxo group; and further preferably one or more groups selected from the group consisting of a halogen atom, an alkyl group, an aryl group, an amino group, and a hydroxy group. Among those, in the case of a halogen atom, a chlorine atom, a fluorine atom, or a bromine atom is preferable. In the case of an alkyl group, a C₁ to C₆ alkyl group, for example, a methyl group, an ethyl group, a propyl group, an isopropyl group, a butyl group, a sec-butyl group, an isobutyl group, a tert-butyl group, a pentyl group, or a hexyl group is preferable. In the case of an alkoxy group, a C₁ to C₆ alkoxy group, for example, a methoxy group, an ethoxy group, a propoxy group, an isopropoxy group, a butoxy group, a sec-butoxy group, an isobutoxy group, a tert-butoxy group, a pentyloxy group, or a hexyloxy group is preferable. In the case of an aryl group, a phenyl group is preferable. In the case of an alkylidene group, a C₁ to C₆ alkylidene group, for example, a methylidene group, an ethylidene group, a propylidene group, a butylidene group, a pentylidene group, or a hexylidene group is preferable. In the case of an acyl group, a C₂ to C₇ acyl group is preferable, a C₂ to C₄ acyl group is more preferable, and an acetyl group is further preferable. These substituents may have an additional substituent. Thus, the substituent in the present invention includes also a fluoroalkyl group such as a trifluoromethyl, as a matter of course.

In a preferable embodiment, X^{Dc} is a phenylene group optionally having a substituent, a naphthylene group optionally having a substituent, an anthracenylene group optionally having a substituent, a furandiyl group optionally having a substituent, a pyridinediyl group optionally having a substituent, a thiophenediyl group optionally having a substituent, a quinolinediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group containing an oxygen atom as a heteroatom composing a heterocycle and optionally having a substituent.

In a further preferable embodiment, X^{Dc} is a phenylene group optionally having a substituent, a naphthylene group optionally having a substituent, or a cycloalkylene group optionally having a substituent.

In formula (1), Y^{Dc} represents —O—, —N═N—, a carbonyl group, an alkenylene group optionally having a substituent, or a single bond.

The number of carbon atoms of an alkenylene group in Y^{Dc} is preferably 2 to 10, more preferably 2 to 6, further preferably 2 or 3, and even more preferably 2. The number of carbon atoms described above does not include the number of carbon atoms of the substituent. Examples of the alkenylene group include an ethenylene group, a propenylene group, a butenylene group, a pentenylene group, a hexenylene group, a heptenylene group, an octenylene group, a nonenylene group and a decenylene group.

The substituent that the alkenylene group in Y^{Dc} may have is as previously mentioned. When the alkenylene group in Y^{Dc} has a plurality of substituents, they may be the same as or different from each other. Among them, the substituent that the alkenylene group in Y^{Dc} may have is preferably one or more groups selected from the group consisting of a halogen atom, an alkyl group, an alkoxy group, an aryl group, an alkylidene group, an amino group, a phosphino group, a formyl group, an acyl group, a cyano group, a nitro group, a hydroxy group, and an oxo group; more preferably one or more groups selected from the group consisting of a halogen atom, an alkyl group, an aryl group, an alkylidene group, an amino group, a hydroxy group, and an oxo group; and further preferably one or more groups selected from the group consisting of a halogen atom, an alkyl group, an aryl group, an amino group, and a hydroxy group. Among those, in the case of a halogen atom, a chlorine atom, a fluorine atom, or a bromine atom is preferable. In the case of an alkyl group, a C₁ to C₆ alkyl group, for example, a methyl group, an ethyl group, a propyl group, an isopropyl group, a butyl group, a sec-butyl group, an isobutyl group, a tert-butyl group, a pentyl group, or a hexyl group is preferable. In the case of an alkoxy group, a C₁ to C₆ alkoxy group, for example, a methoxy group, an ethoxy group, a propoxy group, an isopropoxy group, a butoxy group, a sec-butoxy group, an isobutoxy group, a tert-butoxy group, a pentyloxy group, or a hexyloxy group is preferable. In the case of an aryl group, a phenyl group is preferable. In the case of an alkylidene group, a C₁ to C₆ alkylidene group, for example, a methylidene group, an ethylidene group, a propylidene group, a butylidene group, a pentylidene group, or a hexylidene group is preferable. In the case of an acyl group, a C₂ to C₇ acyl group is preferable, a C₂ to C₄ acyl group is more preferable, and an acetyl group is further preferable. These substituents may have an additional substituent. Thus, the substituent in the present invention includes also a fluoroalkyl group such as a trifluoromethyl, as a matter of course.

In formula (1), n^{Dc} represents an integer of 0 to 2, preferably 0 or 1, and more preferably 0. When there are a plurality of X^{Dc}, they may be the same as or different from each other. When there are a plurality of Y^{Dc}, they may be the same as or different from each other.

In the formula (1), when n^{Dc} is 0, X^{Dc} is preferably a phenylene group optionally having a substituent, a naphthylene group optionally having a substituent, an anthracenylene group optionally having a substituent, a furandiyl group optionally having a substituent, a pyridinediyl group optionally having a substituent, a thiophenediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group containing an oxygen atom as a heteroatom composing a heterocycle and optionally having a substituent; and more preferably a phenylene group optionally having a substituent, a naphthylene group optionally having a substituent, or a cycloalkylene group optionally having a substituent.

In formula (1), when n^{Dc} is 1 or 2, X^{Dc} is preferably a phenylene group optionally having a substituent, a pyridinediyl group optionally having a substituent, or a quinolinediyl group optionally having a substituent; and Y^{Dc} is —O—, —N═N—, a carbonyl group, an alkenylene group optionally having a substituent, or a single bond.

In a preferable embodiment, in formula (1), n^{Dc} is 0 and X^{Dc} is a phenylene group optionally having a substituent.

In a further preferable embodiment, in formula (1), n^{Dc} is 0 and X^{Dc} is a phenylene group optionally having one or more substituents selected from the group consisting of a halogen atom, an alkyl group, an aryl group, an amino group, and a hydroxy group.

In formula (1), examples of the preferable combination of X^{Dc}, Y^{Dc}, and n^{Dc} include the combinations (1) to (57) in Tables 1-1 to 1-7 below. In the tables, * indicates a bond. In the combinations (1) to (57) below, the divalent group represented as X^{Dc} has a substituent at a specific position but the position of the substituent is not particularly limited. A group having a substituent at a different position may also be suitably used as X^{Dc}. As in the case of X^{Dc} in the combination (47), when the cis-form and the trans-form exist caused by positions of the two bonds, both of the forms can be suitably used.

TABLE 1-1

| | X ^{Dc} | Y ^{Dc} | n ^{Dc} |
|---|---|---|---|
| (1) | 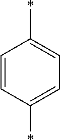 [SMILES: *c1ccc(*)cc1] | — | 0 |
| (2) | 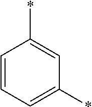 [SMILES: *c1cccc(*)c1] | — | 0 |
| (3) | 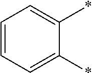 [SMILES: *c1ccccc1*] | — | 0 |
| (4) | 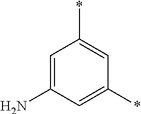 [SMILES: *c1cc(*)cc(N)c1] | — | 0 |
| (5) | 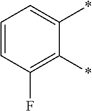 [SMILES: *c1cccc(F)c1*] | — | 0 |
| (6) | 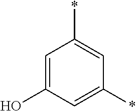 [SMILES: *c1cc(*)cc(O)c1] | — | 0 |
| (7) | 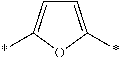 [SMILES: *c1ccc(*)o1] | — | 0 |
| (8) | 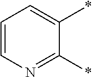 [SMILES: *c1cccnc1*] | — | 0 |
| (9) | 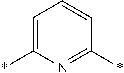 [SMILES: *c1cccc(*)n1] | — | 0 |

TABLE 1-2

| | X^{Dc} | Y ^{Dc} | n ^{Dc} |
|---|---|---|---|
| (10) | 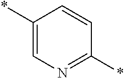 [SMILES: *c1ccc(*)nc1] | — | 0 |
| (11) | 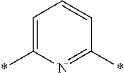 [SMILES: *c1cccc(*)n1] | — | 0 |
| (12) | 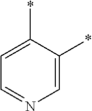 [SMILES: *c1ccncc1*] | — | 0 |
| (13) | 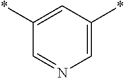 [SMILES: *c1cncc(*)c1] | — | 0 |
| (14) | 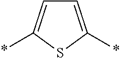 [SMILES: *c1ccc(*)s1] | — | 0 |
| (15) | 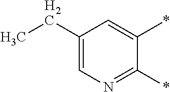 [SMILES: *c1cc(CC)cnc1*] | — | 0 |
| (16) | 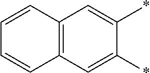 [SMILES: *c1cc2ccccc2cc1*] | — | 0 |
| (17) | 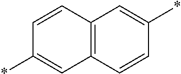 [SMILES: *c1ccc2cc(*)ccc2c1] | — | 0 |
| (18) | 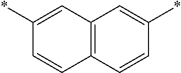 [SMILES: *c1ccc2ccc(*)cc2c1] | — | 0 |

TABLE 1-3

| | X^{Dc} | Y^{Dc} | n^{Dc} |
|---|---|---|---|
| (19) | 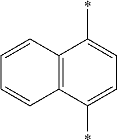 [SMILES: *c1ccc(*)c2ccccc12] | — | 0 |
| (20) | 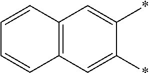 [SMILES: *c1cc2ccccc2cc1*] | — | 0 |
| (21) | 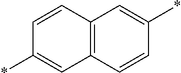 [SMILES: *c1ccc2cc(*)ccc2c1] | — | 0 |
| (22) | 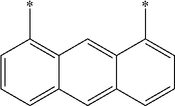 [SMILES: *c1cccc2cc3cccc(*)c3cc12] | — | 0 |
| (23) | 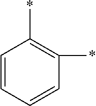 [SMILES: *c1ccccc1*] | Single Bond | 1 |
| (24) | 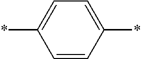 [SMILES: *c1ccc(*)cc1] | Single Bond | 1 |
| (25) | 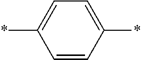 [SMILES: *c1ccc(*)cc1] | 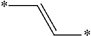 [SMILES: */C=C/*] | 1 |
| (26) | 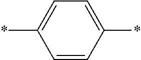 [SMILES: *c1ccc(*)cc1] | 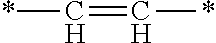 [SMILES: *C=C*] | 1 |

TABLE 1-4

| | X^{Dc} | Y ^{Dc} | n ^{Dc} |
|---|---|---|---|
| (27) | 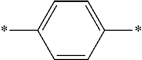 [SMILES: *c1ccc(*)cc1] | *—O—* | 1 |
| (28) | 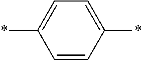 [SMILES: *c1ccc(*)cc1] | *—N═N—* | 1 |
| (29) | 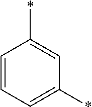 [SMILES: *c1cccc(*)c1] | *—N═N—* | 1 |
| (30) | 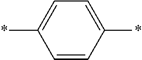 [SMILES: *c1ccc(*)cc1] | *—N═N—* | 1 |
| (31) | 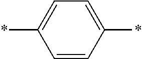 [SMILES: *c1ccc(*)cc1] | 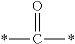 [SMILES: *C(*)=O] | 1 |
| (32) | 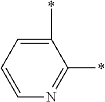 [SMILES: *c1cccnc1*] | Single Bond | 1 |
| (33) | 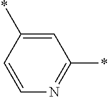 [SMILES: *c1ccnc(*)c1] | Single Bond | 1 |
| (34) | 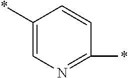 [SMILES: *c1ccc(*)nc1] | Single Bond | 1 |
| (35) | 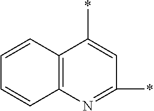 [SMILES: *c1cc(*)c2ccccc2n1] | Single Bond | 1 |

TABLE 1-5

| | X^{Dc} | Y ^{Dc} | n ^{Dc} |
|---|---|---|---|
| (36) | 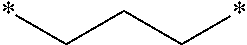 [SMILES: *CCC*] | — | 0 |
| (37) | 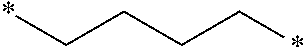 [SMILES: *CCCC*] | — | 0 |
| (38) | 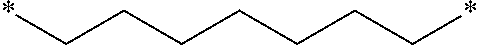 [SMILES: *CCCCCCC*] | — | 0 |
| (39) | 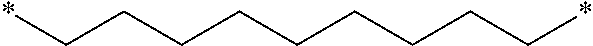 [SMILES: *CCCCCCCCC*] | — | 0 |
| (40) | 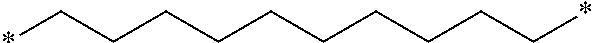 [SMILES: *CCCCCCCCCC*] | — | 0 |
| (41) | 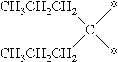 | — | 0 |
| (42) | 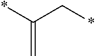 [SMILES: *CC(*)=C] | — | 0 |
| (43) | *—≡—* | — | 0 |
| (44) | 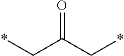 [SMILES: *CC(=O)C*] | — | 0 |

TABLE 1-6

| | X^{Dc} | Y ^{Dc} | n ^{Dc} |
|---|---|---|---|
| (45) | 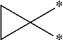 [SMILES: *C1(*)CC1] | — | 0 |
| (46) | 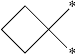 [SMILES: *C1(*)CCC1] | — | 0 |
| (47) | 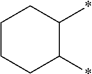 [SMILES: *C1CCCCC1*] | — | 0 |
| (48) | 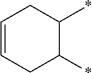 [SMILES: *C1CC=CCC1*] | — | 0 |
| (49) | 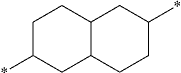 [SMILES: *C1CCC2CC(*)CCC2C1] | — | 0 |
| (50) | 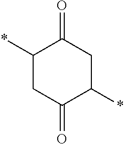 [SMILES: *C1CC(=O)C(*)CC1=O] | — | 0 |
| (51) | 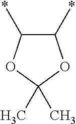 [SMILES: *C1OC(C)(C)OC1*] | — | 0 |
| (52) | 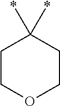 [SMILES: *C1(*)CCOCC1] | — | 0 |
| (53) | 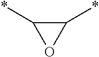 [SMILES: *C1OC1*] | — | 0 |

TABLE 1-7

| | X^{Dc} | Y ^{Dc} | n ^{Dc} |
|---|---|---|---|
| (54) | 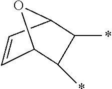 [SMILES: *C1C2C=CC(O2)C1*] | — | 0 |
| (55) | 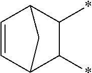 [SMILES: *C1C2C=CC(C2)C1*] | — | 0 |
| (56) | 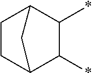 [SMILES: *C1C2CCC(C2)C1*] | — | 0 |
| (57) | 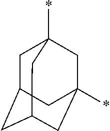 [SMILES: *C12CC3CC(C1)CC(*)(C3)C2] | — | 0 |

Among them, the combination of X^{Dc}, Y^{Dc}, and n^{Dc} is preferably (1) to (6), (16) to (21), (47), and (50) above, and more preferably (1) to (3), (16) to (21), and (47) above.

In a preferable embodiment, the compound represented by the formula (1) is 2-(4-carboxyphenyl)benzo[d]oxazole-5-carboxylic acid represented by formula (1-1) (hereinafter may be abbreviated as “CBOC”).

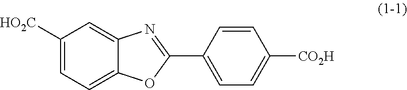 [SMILES: O=C(O)c1ccc(-c2nc3cc(C(=O)O)ccc3o2)cc1]

In another preferable embodiment, the compound represented by formula (1) is 2-(4-carboxyphenyl)benzo[d]oxazole-5-carboxylic acid dichloride (hereinafter may be abbreviated as “CBOC-C1”).

The method of producing the compound represented by formula (1) is not particularly limited. The compound represented by the formula (1) may be produced by any conventionally known method. For example, CBOC can be produced by the method described in Examples below.

The compound represented by formula (1) may be used singly or in combination of two or more thereof

In formula (2), X^{e} represents a monovalent aromatic hydrocarbon group optionally having a substituent. The monovalent aromatic hydrocarbon group in X^{e} refers to a group in which one hydrogen atom is removed from an aromatic ring of an aromatic hydrocarbon (i.e., an aryl group). The number of carbon atoms of the monovalent aromatic hydrocarbon group is preferably 6 to 24, more preferably 6 to 18, further preferably 6 to 14, and even more preferably 6 to 10. The number of carbon atoms described above does not include the number of carbon atoms of the substituent.

Specific examples of the monovalent aromatic hydrocarbon group in X^{e} include a phenyl group, a naphthyl group, and an anthracenyl group. In view of obtaining a polyether ketone compound with high thermal resistance, a phenyl group or a naphthyl group is particularly preferable.

The substituent that the monovalent aromatic hydrocarbon group in X^{e} may have is as previously mentioned. When the monovalent aromatic hydrocarbon group in X^{e} has a plurality of substituents, they may be the same as or different from each other. Among them, the substituent that the monovalent aromatic hydrocarbon group in X^{e} may have is preferably one or more groups selected from the group consisting of a halogen atom, an alkyl group, an alkoxy group, an aryl group, an alkylidene group, an amino group, a phosphino group, a formyl group, an acyl group, a cyano group, a nitro group, a hydroxy group, and an oxo group; more preferably one or more groups selected from the group consisting of a halogen atom, an alkyl group, an alkoxy group, an aryl group, an alkylidene group, a phosphino group, a formyl group, an acyl group, a cyano group, a nitro group, and an oxo group; and further preferably one or more groups selected from the group consisting of a halogen atom, an alkyl group, an alkoxy group, a phosphino group, a formyl group, an acyl group, a cyano group, and a nitro group. Among those, in the case of a halogen atom, a chlorine atom, a fluorine atom, or a bromine atom is preferable. In the case of an alkyl group, a C₁ to C₂₀ alkyl group is preferable, a C₁ to C₆ alkyl group is more preferable, a C₁ to C₃ alkyl group is further preferable, and a methyl group or an ethyl group is even more preferable. In the case of an alkoxy group, a C₁ to C₆ alkoxy group, for example, a methoxy group, an ethoxy group, a propoxy group, an isopropoxy group, a butoxy group, a sec-butoxy group, an isobutoxy group, a tert-butoxy group, a pentyloxy group, or a hexyloxy group is preferable. In the case of an aryl group, a phenyl group is preferable. In the case of an alkylidene group, a C₁ to C₆ alkylidene group, for example, a methylidene group, an ethylidene group, a propylidene group, a butylidene group, a pentylidene group, or a hexylidene group is preferable. In the case of an acyl group, a C₂ to C₇ acyl group is preferable, a C₂ to C₄ acyl group is more preferable, and an acetyl group is further preferable. These substituents may have an additional substituent. Thus, the substituent in the present invention includes also a fluoroalkyl group such as a trifluoromethyl, as a matter of course.

When the monovalent aromatic hydrocarbon group in X^{e} has substituents, the number of the substituents and positions where the substituents bind are not particularly limited, as long as the desired polyether ketone compound can be obtained, and the number and the positions can suitably be determined depending on characteristics of the substituents, such as electron-withdrawing/-donating properties and bulkiness (dimension).

In formula (2), Y^{e} represents a single bond, a divalent aliphatic hydrocarbon group optionally having a substituent, a divalent aromatic group optionally having a substituent, or a divalent non-aromatic heterocyclic group optionally having a substituent.

The divalent aliphatic hydrocarbon group in Y^{e} may be either a saturated hydrocarbon group or an unsaturated hydrocarbon group. The number of carbon atoms thereof is preferably 1 to 60, more preferably 1 to 40, further preferably 1 to 30, even more preferably 1 to 20, and particularly preferably 1 to 10 or 1 to 6. The number of carbon atoms described above does not include the number of carbon atoms of the substituent.

Examples of the divalent aliphatic hydrocarbon group in Y^{e} include an alkylene group, a cycloalkylene group, an alkenylene group, a cycloalkenylene group, an alkynylene group, a cycloalkynylene group, an alkapolyenylene group (the number of double bonds is preferably 2 to 10, more preferably 2 to 6, further preferably 2 to 4, and even more preferably 2), an alkadiynylene group, and an alkatriynylene group. The divalent aliphatic hydrocarbon group in Y^{e} is preferably an alkylene group, a cycloalkylene group, an alkenylene group, or an alkynylene group; and more preferably an alkylene group or a cycloalkylene group.

The number of carbon atoms of an alkylene group in Y^{e} is preferably 1 to 60, more preferably 1 to 40, further preferably 1 to 30, even more preferably 1 to 20, and particularly preferably 1 to 15, 1 to 12, 1 to 9, 1 to 6, or 1 to 3. The number of carbon atoms described above does not include the number of carbon atoms of the substituent. Examples of the alkylene group include a methylene group, an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, an octadecylene group, a nonadecylene group, and an icocylene group.

The number of carbon atoms of a cycloalkylene group in Y^{e} is preferably 3 to 10, and more preferably 3 to 6. The number of carbon atoms described above does not include the number of carbon atoms of the substituent. Examples of the cycloalkylene group include a cyclopropylene group, a cyclobutylene group, a cyclopentylene group, and a cyclohexylene group.

The number of carbon atoms of an alkenylene group in Y^{e} is preferably 2 to 60, more preferably 2 to 40, further preferably 2 to 30, even more preferably 2 to 20, and particularly preferably 2 to 10, 2 to 6, or 2 to 3. The number of carbon atoms described above does not include the number of carbon atoms of the substituent. Examples of the alkenylene group include an ethenylene group, a propenylene group, a butenylene group, a pentenylene group, a hexenylene group, a heptenylene group, an octenylene group, a nonenylene group, a decenylene group, an undecenylene group, a dodecenylene group, a tridecenylene group, a tetradecenylene group, a pentadecenylene group, a hexadecenylene group, a heptadecenylene group, an octadecenylene group, a nonadecenylene group, and an icocenylene group.

The number of carbon atoms of an alkynylene group in Y^{e} is preferably 2 to 60, more preferably 2 to 40, further preferably 2 to 30, even more preferably 2 to 20, and particularly preferably 2 to 10, 2 to 6, or 2 to 3. The number of carbon atoms described above does not include the number of carbon atoms of the substituent. Examples of the alkynylene group include an ethynylene group, a propynylene group, a butynylene group, a pentynylene group, a hexynylene group, a heptynylene group, and an octynylene group.

Examples of the divalent aromatic group in Y^{e} include an arylene group and a heteroarylene group. An arylene group having 6 to 24 carbon atoms and a heteroarylene group having 3 to 21 carbon atoms are preferable. An arylene group having 6 to 18 carbon atoms and a heteroarylene group having 3 to 15 carbon atoms are more preferable. An arylene group having 6 to 14 carbon atoms and a heteroarylene group having 3 to 9 carbon atoms are further preferable. An arylene group having 6 to 10 carbon atoms and a heteroarylene group having 3 to 6 carbon atoms are even more preferable. The number of carbon atoms described above does not include the number of carbon atoms of the substituent.

Specific examples of the divalent aromatic group in Y^{e} include a phenylene group, a naphthylene group, an anthracenylene group, a thiophenediyl group, a pyrrolediyl group, a furandiyl group, a pyridinediyl group, a pyridazinediyl group, a pyrimidinediyl group, a pyrazinediyl group, a triazinediyl group, a quinolinediyl group, and an isoquinolinediyl group. Among them, in view of obtaining a polyether ketone compound with high thermal resistance, the divalent aromatic group in Y^{e} is preferably an arylene group having 6 to 10 carbon atoms; more preferably a phenylene group or a naphthylene group; and further preferably a phenylene group.

The number of carbon atoms of a divalent non-aromatic heterocyclic group in Y^{e} is preferably 2 to 21, more preferably 2 to 15, further preferably 2 to 9, even more preferably 2 to 6, and particularly preferably 2 to 5. The number of carbon atoms described above does not include the number of carbon atoms of the substituent. The divalent non-aromatic heterocyclic group of Y^{e} contains preferably one or more selected from the group consisting of an oxygen atom, a sulfur atom, a nitrogen atom, a phosphorus atom, a boron atom, and a silicon atom; and more preferably one or more selected from the group consisting of an oxygen atom, a sulfur atom, and nitrogen atom; as a heteroatom composing a heterocycle.

Specific examples of the divalent non-aromatic heterocyclic group in Y^{e} include an oxiranediyl group, an aziridinediyl group, an azetidinediyl group, an oxetanediyl group, a thietanediyl group, a pyrrolidinediyl group, a dihydrofurandiyl group, a tetrahydrofurandiyl group, a dioxolanediyl group, a tetrahydrothiophenediyl group, an imidazolidinediyl group, an oxazolidinediyl group, a piperidinediyl group, a dihydropyrandiyl group, a tetrahydropyrandiyl group, a tetrahydrothiopyrandiyl group, a morpholinediyl group, a thiomorpholinediyl group, a piperazinediyl group, a dihydrooxazinediyl group, a tetrahydrooxazinediyl group, a dihydropyrimidinediyl group, a tetrahydropyrimidinediyl group, and an exo-3,6-epoxy-1,2,3,6-tetrahydrophenylene group.

The substituent that the divalent group in Y^{e} may have is as previously mentioned. When the divalent group in Y^{e} has a plurality of substituents, they may be the same as or different from each other. Among them, the substituent that the divalent group in Y^{e} may have is preferably one or more groups selected from the group consisting of a halogen atom, an alkyl group, an alkoxy group, an aryl group, an alkylidene group, an amino group, a phosphino group, a formyl group, an acyl group, a cyano group, a nitro group, a hydroxy group, and an oxo group; more preferably one or more groups selected from the group consisting of a halogen atom, an alkyl group, an alkoxy group, an aryl group, an alkylidene group, a phosphino group, a formyl group, an acyl group, a cyano group, a nitro group, and an oxo group; and further preferably one or more groups selected from the group consisting of a halogen atom, an alkyl group, an alkoxy group, a phosphino group, a formyl group, an acyl group, a cyano group, and a nitro group. Among those, in the case of a halogen atom, a chlorine atom, a fluorine atom, or a bromine atom is preferable. In the case of an alkyl group, a C₁ to C₂₀ alkyl group is preferable, a C₁ to C₆ alkyl group is more preferable, a C₁ to C₃ alkyl group is further preferable, and a methyl group or an ethyl group is even more preferable. In the case of an alkoxy group, a C₁ to C₆ alkoxy group, for example, a methoxy group, an ethoxy group, a propoxy group, an isopropoxy group, a butoxy group, a sec-butoxy group, an isobutoxy group, a tert-butoxy group, a pentyloxy group, or a hexyloxy group is preferable. In the case of an aryl group, a phenyl group is preferable. In the case of an alkylidene group, a C₁ to C₆ alkylidene group, for example, a methylidene group, an ethylidene group, a propylidene group, a butylidene group, a pentylidene group, or a hexylidene group is preferable. In the case of an acyl group, a C₂ to C₇ acyl group is preferable, a C₂ to C₄ acyl group is more preferable, and an acetyl group is further preferable. These substituents may have an additional substituent. Thus, the substituent in the present invention includes also a fluoroalkyl group such as a trifluoromethyl, as a matter of course.

In a further preferable embodiment, in formula (2), Y^{e} is a single bond, an alkylene group optionally having a substituent, a cycloalkylene group optionally having a substituent, a phenylene group optionally having a substituent, a naphthylene group optionally having a substituent, a furandiyl group optionally having a substituent, a pyridinediyl group optionally having a substituent, a thiophenediyl group optionally having a substituent, a quinolinediyl group optionally having a substituent, or a divalent non-aromatic heterocyclic group containing one or more selected from the group consisting of an oxygen atom, a sulfur atom and a nitrogen atom as a heteroatom composing a heterocycle and optionally having a substituent.

In formula (2), Z^{e} represents a monovalent aromatic hydrocarbon group optionally having a substituent. The definition and preferable examples of the monovalent aromatic hydrocarbon group in Z^{e} are same as those of the monovalent aromatic hydrocarbon group in X^{e}.

The substituent that the monovalent aromatic hydrocarbon group in Z^{e} may have is as previously mentioned. When the monovalent aromatic hydrocarbon group in Z^{e} has a plurality of substituents, they may be the same as or different from each other. Preferable examples of the substituent that the monovalent aromatic hydrocarbon group in Z^{e} may have are as previously explained for the monovalent aromatic hydrocarbon group in X^{e}. When the monovalent aromatic hydrocarbon group in Z^{e} has substituents, the number of the substituents and positions where the substituents bind are not particularly limited, as long as the desired polyether ketone compound can be obtained, and the number and the positions can suitably be determined depending on characteristics of the substituents, such as electron-withdrawing/-donating properties and bulkiness (dimension).

In formula (2), X^{e} and Z^{e} may be the same as or different from each other. In a preferable embodiment, in the formula (2), each of X^{e} and Z^{e} is individually a phenyl group optionally having a substituent or a naphthyl group optionally having a substituent.

In formula (2), n^{e} is an integer of 1 to 5, preferably an integer of 1 to 4, more preferably an integer of 1 to 3, and further preferably an integer of 1 or 2. When there are a plurality of Y^{e}, they may be the same as or different from each other.

In a preferable embodiment, in formula (2), n^{e} is 1 or 2, each of X^{e} and Z^{e} is a phenyl group optionally having a substituent, Y^{e} is a single bond or an alkylene group having 1 to 6 carbon atoms and optionally having a substituent.

In a further preferable embodiment, in formula (2), n^{e} is 1 or 2; each of X^{e} and Z^{e} is a phenyl group optionally having one or more substituents selected from the group consisting of a halogen atom, an alkyl group, an alkoxy group, a phosphino group, a formyl group, an acyl group, a cyano group, and a nitro group; and Y^{e} is a single bond or an alkylene group having 1 to 6 carbon atoms and optionally having one or more substituents selected from the group consisting of a halogen atom, an alkyl group, an alkoxy group, a phosphino group, a formyl group, an acyl group, a cyano group, and a nitro group.

In a preferable embodiment, the compound represented by formula (2) is one or more selected from the group consisting of compounds represented by formulae (2-1) to (2-19) below.

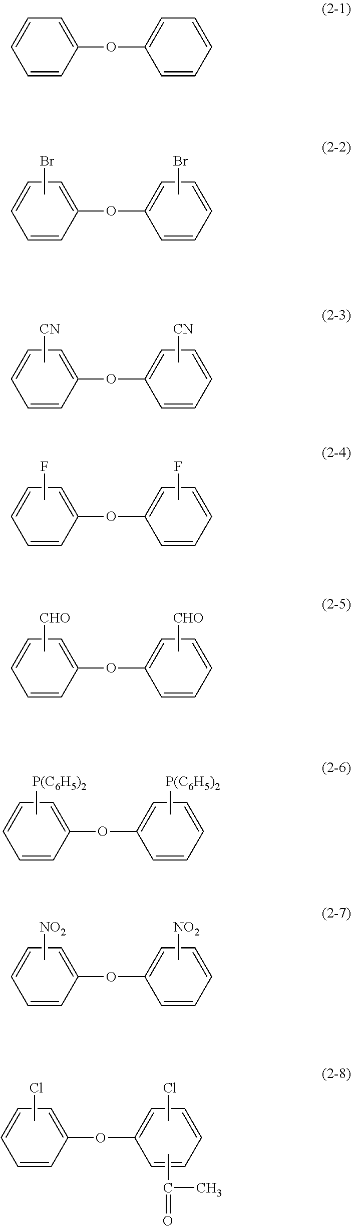

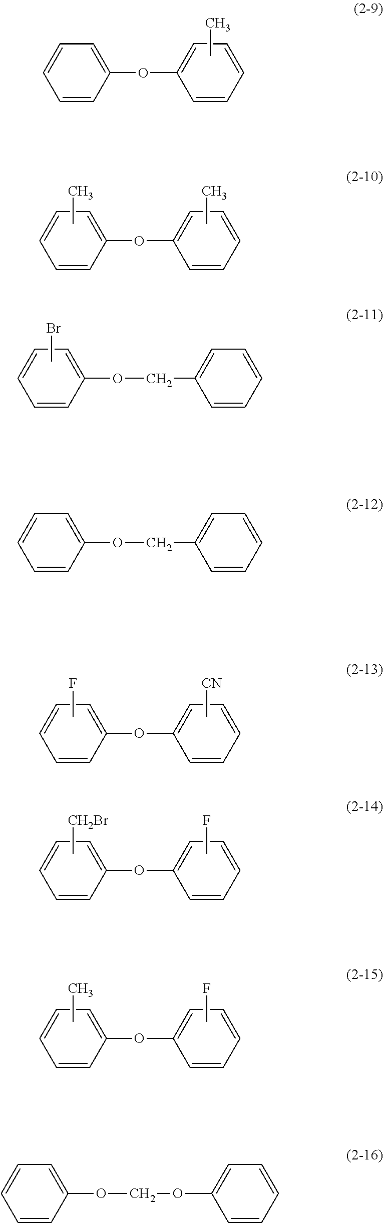

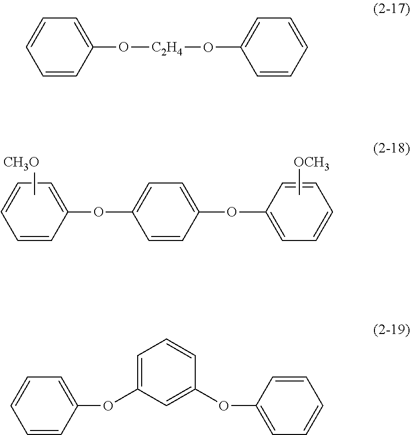

X^{e}, Y^{e}, Z^{e} and n^{e} in each of the formulae (2-1) to (2-19) are listed in Tables 2-1 to 2-3 below. In the tables, * represents a bond.

TABLE 2-1

| | | | | | Compound |
|---|---|---|---|---|---|
| | X^{e} | Y^{e} | Z^{e} | n^{e} | name |
| (2-1) | 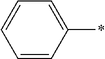 [SMILES: *c1ccccc1] | Single Bond | 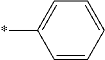 [SMILES: *c1ccccc1] | 1 | Diphenyl Ether |
| (2-2) | 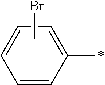 | Single Bond | 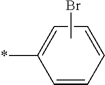 | 1 | Bis(bromophenyl) Ether |
| (2-3) | 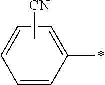 | Single Bond | 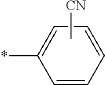 | 1 | Bis(cyanophenyl) Ether |
| (2-4) | 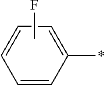 | Single Bond | 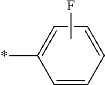 | 1 | Bis(fluorophenyl) Ether |
| (2-5) | 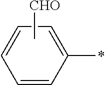 | Single Bond | 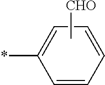 | 1 | Bis(formylphenyl) Ether |
| (2-6) | 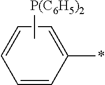 | Single Bond | 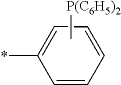 | 1 | Bis[(diphenyl- phosphino)phenyl] Ether |

TABLE 2-2

| | X^{e} | Y^{e} | Z^{e} | n^{e} | Compound name |
|---|---|---|---|---|---|
| (2-7) | 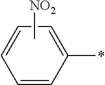 | Single Bond | 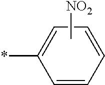 | 1 | Bis (nitrophenyl) Ether |
| (2-8) | 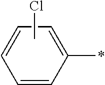 | Single Bond | 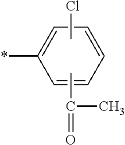 | 1 | Chlorophenyl (monoacetyl monochlorophenyl) Ether |
| (2-9) | 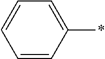 [SMILES: *c1ccccc1] | Single Bond | 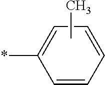 | 1 | Phenyltolyl Ether |
| (2-10) | 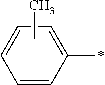 | Single Bond | 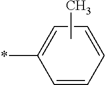 | 1 | Ditolyl Ether |
| (2-11) | 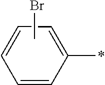 | *—CH₂— | 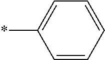 [SMILES: *c1ccccc1] | 1 | Bromophenyl benzyl Ether |
| (2-12) | 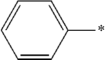 [SMILES: *c1ccccc1] | *—CH₂— | 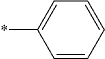 [SMILES: *c1ccccc1] | 1 | Phenylbenzyl Ether |
| (2-13) | 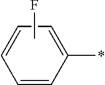 | Single Bond | 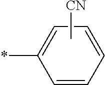 | 1 | Fluorophenyl Cyanophenyl Ether |

TABLE 2-3

| | X^{e} | Y^{e} | Z^{e} | n^{e} | Compound name |
|---|---|---|---|---|---|
| (2-14) | 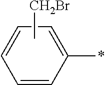 | Single Bond | 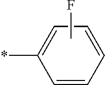 | 1 | Monobromomethyl phenyl (fluorophenyl) Ether |
| (2-15) | 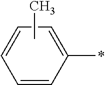 | Single Bond | 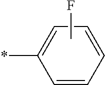 | 1 | Benzyl fluorophenyl Ether |
| (2-16) | 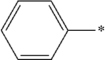 [SMILES: *c1ccccc1] | *—CH₂—* Single Bond | 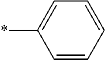 [SMILES: *c1ccccc1] | 2 | Methylene Glycol Diphenyl Ether |
| (2-17) | 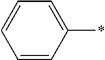 [SMILES: *c1ccccc1] | *—C₂H₄—* Single Bond | 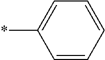 [SMILES: *c1ccccc1] | 2 | Ethylene Glycol Diphenyl Ether |
| (2-18) | 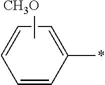 | 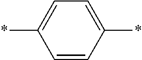 [SMILES: *c1ccc(*)cc1] Single Bond | 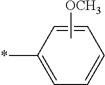 | 2 | 1,4-Bis (methoxyphenoxy) benzene |
| (2-19) | 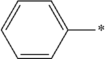 [SMILES: *c1ccccc1] | 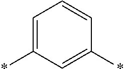 [SMILES: *c1cccc(*)c1] Single Bond | 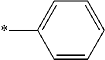 [SMILES: *c1ccccc1] | 2 | 1,3-Diphenoxy benzene |

The compound represented by formula (2) may be used singly or in combination of two or more thereof

In a preferable embodiment, the compound represented by formula (2) is a compound represented by the formula (2-1), (2-9), or (2-17).

The polyether ketone compound of the present invention may be produced by using other compounds as a raw material, in addition to the compound represented by formula (1) and the compound represented by formula (2), as long as the effect of the present invention is not impaired.

Examples of such other compounds include aromatic dicarboxylic acids, a salt thereof, an ester thereof, and a halide thereof. Therefore, in a preferable embodiment, the polyether ketone compound of the present invention can be obtained by reacting the compound represented by formula (1), the compound represented by formula (2), and one or more compounds selected from an aromatic dicarboxylic acid, a salt of an aromatic dicarboxylic acid, an ester of an aromatic dicarboxylic acid, and a halide of an aromatic dicarboxylic acid.

The number of carbon atoms in the aromatic dicarboxylic acid that may be used for producing the polyether ketone compound of the present invention is preferably 8 to 18, more preferably 8 to 16, and further preferably 8 to 14. Examples of the salt of aromatic dicarboxylic acid include alkali metal salts. Among them, lithium salts, sodium salts, potassium salts, and cesium salts are preferable, and potassium salts are more preferable. Examples of the ester of aromatic dicarboxylic acid include a C₁-C₁₀ alkyl ester (preferably a C₁-C₆ alkyl ester and more preferably a C₁-C₄ alkyl ester) and a C₆-C₁₈ aryl ester (preferably a C₆-C₁₄ aryl ester and more preferably a C₆-C₁₀ aryl ester). Examples of the halide of aromatic dicarboxylic acid include fluorides, chlorides, bromides, and iodides, and chlorides are preferable.

Examples of an aromatic dicarboxylic acid, a salt thereof, an ester thereof, and a halide thereof that may be used for producing the polyether ketone compound of the present invention include terephthalic acid, isophthalic acid, 2,6-naphthalenedicarboxylic acid, 4,4′-biphenyldicarboxylic acid, 4,4′-dicarboxydiphenyl ether, 4,4′-dicarboxydiphenylsulfone, terephthalic acid dipotassium salt, isophthalic acid dipotassium salt, terephthalic acid dimethyl ester, isophthalic acid dimethyl ester, terephthalic acid dichloride, and isophthalic acid dichloride. Among them, terephthalic acid, isophthalic acid, and 2,6-naphthalenedicarboxylic acid, are preferable.

The polyether ketone compound of the present invention includes one or more structural units selected from the group consisting of structural units represented by the formulae (i) to (iv).

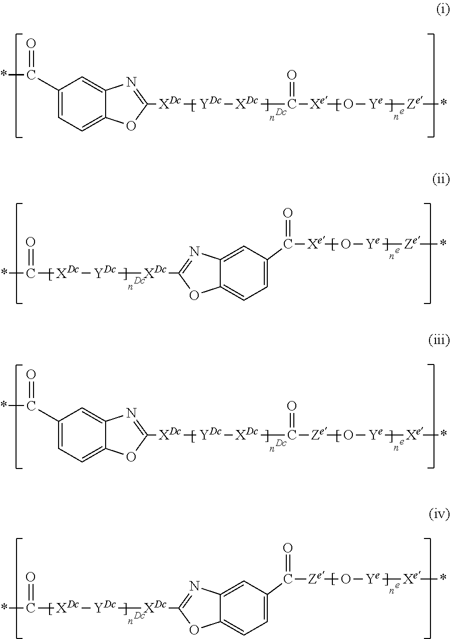

wherein in formulae (i) to (iv), X^{Dc}, Y^{Dc}, Y^{e}, n^{Dc}, and n^{e} represent the same meanings as defined above, and * represents a bond. X^{e′} is a group in which one hydrogen atom is further removed from an aromatic ring of X^{e}, and represents a divalent aromatic hydrocarbon group optionally having a substituent. Z^{e′} is a group in which one hydrogen atom is removed from an aromatic ring of Z^{e}, and represents a divalent aromatic hydrocarbon group optionally having a substituent.)

Preferable examples of X^{Dc}, Y^{Dc}, and Y^{e}, as well as preferable ranges of n^{Dc} and n^{e} are as previously mentioned. Also, preferable examples of X^{e} and Z^{e} resulting in X^{e′} and Z^{e′} are as previously mentioned.

The number of carbon atoms of the divalent aromatic hydrocarbon group in each of X^{e′} and Z^{e′} is preferably 6 to 24, more preferably 6 to 18, further preferably 6 to 14, and even more preferably 6 to 10. Specific examples of the divalent aromatic hydrocarbon group in each of X^{e′} and Z^{e′} include a phenylene group, a naphthylene group, and an anthracenylene group. In view of obtaining a polyether ketone compound with high thermal resistance, the divalent aromatic hydrocarbon group in each of X^{e′} and Z^{e′} is particularly preferably a phenylene group or a naphthylene group.

Preferable examples of the substituent that the divalent aromatic hydrocarbon group in each of X^{e′} and Z^{e′} may have are same as those of the substituent that the monovalent aromatic hydrocarbon group in each of X^{e} and Z^{e} may have.

In a preferable embodiment, each of X^{e′} and Z^{e′} is individually a phenylene group optionally having a substituent or a naphthylene group optionally having a substituent.

When the polyether ketone compound of the present invention is produced by using any of other compounds as a raw material, in addition to the compound represented by formula (1) and the compound represented by formula (2), the polyether ketone compound of the present invention may further contain structural units derived from the other compounds. For example, when the aromatic dicarboxylic acid of above is used as the other compound, the polyether ketone compound of the present invention may further contain one or more selected from the group consisting of structural units represented by the formulae (v) and (vi) below.

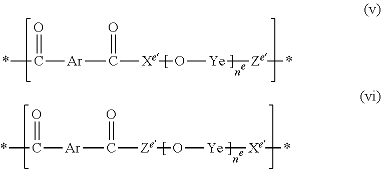

wherein in formulae (v) and (vi), X^{e′}, Y^{e}, Z^{e′} and n^{e} represent the same meanings as defined above, Ar represents an arylene group, and * represents a bond.)

In the formulae (v) and (vi), the arylene group represented by Ar represents an arylene group derived from the aromatic dicarboxylic acid used as the “other compound”. The number of carbon atoms in the arylene group represented by Ar is preferably 6 to 16, more preferably 6 to 14, further preferably 6 to 12, and even more preferably 6 to 10. Preferable specific examples of the arylene group represented by Ar include a 1,4-phenylene group, a 1,3-phenylene group, and a 2,6-naphthylene group.

When producing the polyether ketone compound of the present invention, the ratio of the amount (mole) of the other compounds to the total amount (mole) of the compound represented by formula (1) and the compound represented by formula (2), that is, the molar ratio of (other compounds)/((the compound represented by formula (1))+(the compound represented by formula (2))) is preferably 1/2 or less, more preferably 3/10 or less, further preferably 1/5 or less, and even more preferably 1/10 or less, in view of obtaining a polyether ketone compound with high thermal resistance. The lower limit of the molar ratio is not particularly limited and may be 0.

When the aromatic dicarboxylic acid above is used as the other compound, the ratio of the total amount (mole) of the compound represented by formula (1) and the aromatic dicarboxylic acid to the amount (mole) of the compound represented by formula (2), that is, the molar ratio of ((the compound represented by the formula (1))+(aromatic dicarboxylic acid))/(the compound represented by the formula (2)) is usually 1/10 to 10/1; preferably 1/3 to 3/1; more preferably 1/1.5 to 1.5/1; further preferably 1/1.1 to 1.1/1, or 1/1.05 to 1.05/1.

The reaction of the compound represented by formula (1) and the compound represented by formula (2) and, if necessary, other compounds can be conducted according to the Friedel-Crafts acylation reaction that is one type of aromatic electrophilic substitution reaction. Specifically, generating an acyl cation from the compound represented by formula (1) (and other compounds used as necessary) under the presence of a suitable catalyst; and substituting a hydrogen atom of an aromatic ring of the compound represented by the formula (2) (i.e., each of aromatic rings of X^{e} and Z^{e}) with the acyl cation.

The catalyst used in the reaction of the compound represented by formula (1) and the compound represented by formula (2) and, if necessary, other compounds is not particularly limited, and any conventional known catalysts can be used as long as the catalyst allows the generation of an acyl cation from the compound represented by formula (1) (and other compounds used as necessary) and to proceed the Friedel-Crafts acylation reaction. Examples of preferable catalysts include a Lewis acid and a protonic acid (Bronsted acid). The Lewis acid is preferably a halide belonging to any of Groups 8 to 14 of the periodic table, and specific examples thereof include aluminum chloride, aluminum bromide, iron chloride, iron bromide, zinc chloride, zirconium chloride, tin chloride, boron chloride, and boron fluoride. Examples of the protonic acid include inorganic protonic acids (for example, hydrofluoric acid, hydrochloric acid, sulfuric acid, nitric acid, perchloric acid, orthophosphoric acid, and polyphosphoric acid); aromatic sulfonic acids (for example, benzenesulfonic acid and p-toluenesulfonic acid); and aliphatic sulfonic acids (for example, methanesulfonic acid and ethanesulfonic acid). Eaton's reagent that is a mixture of phosphorus pentoxide and methanesulfonic acid is also a preferable protonic acid catalyst. The catalyst may be used singly or in combination of two or more thereof.

The reaction may be conducted in a solvent. Examples of the solvent include pyridine, N,N-dimethylformamide, N,N-dimethylacetamide, N-methyl-2-pyrrolidone, carbon tetrachloride, hexachloroethane, 1,2-dichloroethane, chlorobenzene, and o-dichlorobenzene. If the catalyst allows the dissolution or dispersion of the compound represented by formula (1) and the compound represented by formula (2) under the reaction condition, the catalyst may serve as the solvent. The solvent may be used singly or in combination of two or more thereof.

The reaction is preferably conducted in an inert gas atmosphere such as argon and nitrogen, and is preferably conducted under atmospheric pressure (normal pressure).

The reaction temperature is not particularly limited as long as an acylation reaction proceeds, and is preferably −10° C. to 200° C., more preferably 0° C. to 150° C., and further preferably 20° C. to 120° C.

The reaction time varies depending on the kind of the raw material, the reaction temperature, and other factors, and it is preferably 0.1 hour to 24 hours, more preferably 0.5 hour to 18 hours, and further preferably 1 hour to 18 hours.

The glass transition temperature (T_{g}) of the polyether ketone compound of the present invention is preferably 140° C. or higher, more preferably 145° C. or higher, and further preferably 150° C. or higher. The polyether ketone compound of the present invention obtained by reacting the compound represented by formula (1) with the compound represented by formula (2) can achieve a high T_{g}, for example, T_{g} of 155° C. or higher, 160° C. or higher, 165° C. or higher, 170° C. or higher, 175° C. or higher, 180° C. or higher, 185° C. or higher, 190° C. or higher, 195° C. or higher, or 200° C. or higher. Although the upper limit of T_{g} is not particularly limited, it is usually 400° C. or lower.

T_{g} can be measured, for example, by using a differential scanning calorimeter.

The melting point (Tₘ) of the polyether ketone compound of the present invention is preferably 300° C. or higher, more preferably 310° C. or higher, and further preferably 320° C. or higher. The polyether ketone compound of the present invention obtained by reacting the compound represented by formula (1) with the compound represented by formula (2) can achieve a high Tₘ, for example, Tₘ of 330° C. or higher, 340° C. or higher, 350° C. or higher, or 360° C. or higher. Although the upper limit of Tₘ is not particularly limited, it is usually 500° C. or lower.

Tₘ can be measured, for example, by using a differential scanning calorimeter.

The 5% mass reduction temperature (T_{d}; the temperature at a point of time when the mass of the polyether ketone compound is reduced by 5% when the polyether ketone compound is heated from room temperature at a certain rate of temperature increase) of the polyether ketone compound of the present invention is preferably 300° C. or higher, more preferably 320° C. or higher, and further preferably 340° C. or higher. The polyether ketone compound of the present invention obtained by reacting the compound represented by formula (1) with the compound represented by formula (2) can achieve a high T_{d}, for example, T_{d} of 350° C. or higher, 360° C. or higher, 370° C. or higher, 380° C. or higher, 390° C. or higher, or 400° C. or higher. Although the upper limit of T_{d} is not particularly limited, it is usually 500° C. or lower.

T_{d} can be measured, for example, by using a thermogravimetric apparatus.

The polyether ketone compound of the present invention has high thermal resistance and therefore can be suitably used as engineering plastics. The polyether ketone compound of the present invention can be suitably used as engineering plastics, for example, in automobile and aircraft fields, electrics and electronics fields, a machine field, and other fields (for example, health care devices, heat resistant sheets, and heat resistant fibers). Specifically, examples of applications in the automobile and aircraft fields include engine covers, intake manifolds, door mirror stays, gas pedals, industrial fasteners, armrests, seat belt parts, door handles, power steering oil reservoir tanks, radiator grilles, and cooling fans. Examples of applications in the electrics and electronics fields include gears, hubs, coil bobbins, connectors, motor brackets, ferrite binders, magnet switch parts, circuit breaker housings, various plugs, and solderless terminals. Examples of applications in the machine field include bearings, bearing retainers, gears, fans, impellers, filter bowls, pulleys, and casters. The polyether ketone compound of the present invention can also be used for applications for toys, packaging materials (for example, films and tubes), food or beverage containers, and the like.

### Method of Producing Polyether Ketone Compound

The present invention also provides a method of producing a polyether ketone compound.

In an embodiment, a method of producing a polyether ketone compound of the present invention includes a step of reacting a compound represented by formula (1) with a compound represented by formula (2).

The compound represented by formula (1), the compound represented by formula (2), and the reaction conditions (including the catalyst, solvent, molar ratio, reaction temperature, reaction pressure, and reaction time) are as previously mentioned.

In producing the polyether ketone compound of the present invention, the ratio in amount (mole) between the compound represented by formula (1) and the compound represented by formula (2), that is, the molar ratio of (the compound represented by the formula (1))/(the compound represented by the formula (2)) is 1/10 to 10/1 in view of obtaining a polyether ketone compound with high thermal resistance. The molar ratio of (the compound represented by the formula (1))/(the compound represented by the formula (2)) is preferably 1/3 to 3/1; more preferably 1/1.5 to 1.5/1; and further preferably 1/1.1 to 1.1/1, or 1/1.05 to 1.05/1.

In the method of producing a polyether ketone compound of the present invention, a polyether ketone compound may be produced by using other compounds, as a raw material, in addition to the compound represented by the formula (1) and the compound represented by the formula (2) as long as the effect of the present invention is not impaired. Examples of the other compounds include an aromatic dicarboxylic acid, a salt of an aromatic dicarboxylic acid, an ester of an aromatic dicarboxylic acid, and a halide of an aromatic dicarboxylic acid.

In a preferable embodiment, the method of producing a polyether ketone compound of the present invention includes a step of reacting a compound represented by formula (1), a compound represented by a formula (2), and one or more compounds selected from the group consisting of aromatic dicarboxylic acid, a salt of an aromatic dicarboxylic acid, an ester of an aromatic dicarboxylic acid, and a halide of an aromatic dicarboxylic acid.

The aromatic dicarboxylic acid, the salt thereof, the ester thereof, and the halide thereof are as previously mentioned.

When a polyether ketone compound is produced by reacting the compound represented by formula (1) and the compound represented by formula (2) and, if necessary, other compounds, a solution polymerization process in which an acylation reaction is conducted in a solvent for polymerization is preferable; however, other polymerization processes may be used to produce the polyether ketone compound. The procedures and conditions of these polymerization processes are well known in the art.

Other features of the invention will become apparent in the course of the following descriptions of exemplary embodiments which are given for illustration of the invention and are not intended to be limiting thereof.

### EXAMPLES

The temperatures are indicated in centigrade unless otherwise specified. The abbreviations used in Examples include: 2-(4-carboxyphenyl)benzo[d]oxazole-5-carboxylic acid: CBOC. The structures of the synthesized compounds were identified by proton nuclear magnetic resonance (¹H-NMR) spectra using a nuclear magnetic resonance apparatus (“AVANCE400” (400 MHz) manufactured by Bruker Corporation). The chemical shift (δ) is indicated in ppm.

### Synthesis Example 1

### Synthesis of 2-(4-carboxyphenyl)benzo[d]oxazole-5-carboxylic acid (CBOC)

CBOC was synthesized in accordance with the procedures (1) to (4) below.

### (1) Synthesis of 3-amino-4-hydroxybenzoic acid methyl ester hydrochloride

Into 250 mL of methanol, 32.0 g (407 mmol) of acetyl chloride was added dropwise under ice cooling. After stirring at room temperature for 30 minutes, 27.9 g of 3-amino-4-hydroxybenzoic acid (182 mmol) was added and dissolved therein, followed by heating and stirring at 80° C. for 4 hours. After being cooled to room temperature, the solution was condensed, and the resultant residue was washed with 250 mL of ethyl acetate and cooled to 0° C., followed by filtration and separation to yield a white solid. This solid was dried overnight at 50° C. under a reduced pressure, thus obtaining 30.7 g (151 mmol) of the titled compound (yield 83%).

¹H-NMR (400 MHz, DMSO-d6) δ: 3.81 (3H, s), 7.14 (1H, d, J=8.52 Hz), 7.78 (1H, dd, J=8.52, 2.12 Hz), 7.92 (1H, d, J=2.12 Hz).

### (2) Synthesis of 2-hydroxy-5-methoxycarbonyl-N-(4-methoxycarbonyl-benzylidene)aniline

Into 300 mL of methanol, 30.7 g (151 mmol) of 3-amino-4-hydroxybenzoic acid methyl ester hydrochloride was dissolved and 15.6 g (154 mmol) of triethyl amine was added dropwise. Thereafter, 24.8 g (151 mmol) of terephthalaldehydic acid methyl ester was added therein and the resultant was stirred at room temperature for 3 hours, followed by condensation and drying to yield a yellow solid. This solid was dried overnight at 50° C. under a reduced pressure, thus obtaining 47.2 g (151 mmol) of the titled compound (yield 100%).

¹H-NMR (400 MHz, CDCl₃) δ: 3.92 (3H, s), 3.97 (3H, s), 7.06 (1H, d, J=8.5 Hz), 7.59 (1H, br), 7.95 (1H, dd, J=8.52, 1.96 Hz), 8.00-8.02 (2H, m), 8.07 (1H, d, J=1.96 Hz), 8.16-8.18 (2H, m), 8.86 (1H, s).

### (3) Synthesis of 2-[4-(methoxycarbonyl)phenyl]benzo[d]oxazole-5-carboxylic acid methyl ester

Into 500 mL of dichloromethane, 47.2 g (151 mmol) of 2-hydroxy-5-methoxycarbonyl-N-(4-methoxycarbonylbenzylidene)aniline was dissolved and cooled to 0° C., and then 34.3 g (151 mmol) of 2,3-dichloro-5,6-dicyano-p-benzoquinone was added therein and the resultant was stirred at 0° C. for 1 hour. A brown solid obtained by condensation and drying was washed with 1 L of an aqueous solution of 5% by weight potassium carbonate and filtered to yield a brown solid. This solid was washed by using 100 mL of toluene and filtered to yield a pale brown solid. This solid was dried overnight at 50° C. under a reduced pressure, thus obtaining 40.8 g (131 mmol) of the titled compound (yield 87%).

¹H-NMR (400 MHz, CDCl₃) δ: 3.92 (3H, s), 3.97 (3H, s), 7.65 (1H, d, J=9.12 Hz), 8.15 (1H, dd, J=8.56, 1.64 Hz), 8.20-8.22 (21-1, m), 8.34-8.36 (2H, m), 8.50 (1H, m).

### (4) Synthesis of CBOC

Into 100 mL of a solution of 1,4-dioxane/water=1/1, 10.0 g (32.1 mmol) of 2-[4-(methoxycarbonyl)phenyl]benzo[d]oxazole-5-carboxylic acid methyl ester was dissolved, and 3.37 g (80.3 mmol) of lithium hydroxide monohydrate was added thereto, and the resultant was heated and stirred at 50° C. for 1 hour. After being cooled to room temperature, the solution was condensed, and the resultant residue was dissolved in 150 mL of water and neutralized with concentrated hydrochloric acid to pH 3.0. The solid obtained by filtering the product was washed with 100 mL of methanol to yield a pale brown solid. This solid was dried overnight at 50° C. under a reduced pressure, thus obtaining 8.18 g (28.9 mmol) of the titled compound (yield 90%).

¹H-NMR (400 MHz, CDCl₃) δ: 7.94 (1H, d, J=8.96 Hz), 8.09 (1H, dd, J=8.52, 1.68 Hz), 8.16-8.18 (2H, m), 8.34-8.36 (3H, m).

### Example 1

### Synthesis of Polyether Ketone by Using CBOC and Diphenyl Ether as Monomers

Into 9.0 mL of Eaton's reagent (a phosphorus pentoxide-methanesulfonic acid solution, the ratio by weight was 1:10), 0.849 g (3.00 mmol) of CBOC and 0.511 g (3.00 mmol) of diphenyl ether having the structure below were suspended, followed by stirring at 120° C. for 17 hours under argon atmosphere. The reaction mixture was added into a 50-fold volume of water, and the pH was adjusted to 7.0 with a 25% by weight/volume of sodium hydroxide aqueous solution. After filtration, a pale brown solid was obtained. This solid was washed twice with 300 mL of water, and then filtered to obtain a pale brown solid. This solid was washed once with 100 mL of methanol, and then filtered to obtain a pale brown solid. This solid was dried overnight at 50° C. under a reduced pressure, thus obtaining 0.940 g of the objective polyether ketone compound (yield 75%).

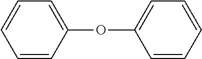 [SMILES: c1ccc(Oc2ccccc2)cc1]

The resultant polyether ketone compounds were evaluated with regard to (1) and (2) below. The results are listed in Table 3.

(1) Measurement of the Glass Transition Temperature, T_{g}, and the Melting Point, Tₘ.

T_{g} and Tₘ were measured by using a differential scanning calorimeter (“DSC6200” manufactured by Seiko Instruments Inc.). The temperature was increased from 30° C. to a temperature that is 10° C. lower than the T_{d} measured as described below (T_{d}−10(° C.)) at a rate of temperature increase of 10° C./minute. The glass transition temperature T_{g} was obtained from the temperature at the point of intersection between a straight line extended from the base line on the low-temperature side toward the high temperature side in the DSC thermogram and a tangent line at a point that the gradient of the curve of stepwise changes of glass transition is largest, and the melting point Tₘ (° C.) was obtained from the top of the endothermic peak.

### (2) Measurement of 5% Mass Reduction Temperature, T_{d}.

T_{d} was measured by using a thermogravimetric apparatus (“TG/DTA6200” manufactured by Seiko Instruments Inc.). In the furnace under a nitrogen atmosphere, heating was conducted from room temperature to 550° C. at a rate of temperature increase of 10° C./minute. The temperature T_{d} (° C.) at which the mass was reduced by 5% was obtained from the resultant thermogravimetric curve.

Examples and Reference Examples below were evaluated similarly. The results thereof are also listed in Table 3.

### Example 2

### Synthesis of Polyether Ketone by Using CBOC and Phenyltolyl Ether as Monomers

The same operation as in Example 1 was performed except that phenyltolyl ether having the structure below was used instead of diphenyl ether, thus obtaining 1.26 g of the objective polyether ketone compound (pale brown) (yield 97%).

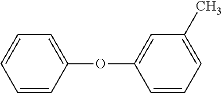

### Example 3

### Synthesis of Polyether Ketone by Using CBOC and Ethylene Glycol Diphenyl Ether as Monomers

The same operation as in Example 1 was performed except that ethylene glycol diphenyl ether having the structure below was used instead of diphenyl ether, thus obtaining 1.35 g of the objective polyether ketone compound (pale brown) (yield 98%).

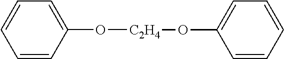

### Reference Example 1

### Evaluation of Thermal Characteristics of Poly[(hydroquinone)-alt-(4,4′-difluorobenzophenone)]

T_{g}, Tₘ, and T_{d} of the polyether ketone compound (“poly[(hydroquinone)-alt-(4,4′-difluorobenzophenone)]” manufactured by GENERAL SCIENCE CORPORATION) containing the structural unit represented by the formula below were evaluated similarly to Example 1. In the formula below, * represents a bond.

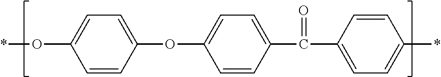

### Reference Example 2

### Synthesis of Polyether Ketone by Using Terephthalic Acid and Diphenyl Ether as Monomers

The same operation as in Example 1 was performed except that terephthalic acid was used instead of CBOC, thus obtaining 0.82 g of the polyether ketone compound (pale brown) (yield 91%).

TABLE 3

| | | Dicarboxylic | | Tg | Tm | Td |
|---|---|---|---|---|---|---|
| | | Acid Monomer | Ether Monomer | (° C.) | (° C.) | (° C.) |
| Example | 1 | CBOC | Diphenyl Ether | 166 | 338 | 453 |
| | 2 | CBOC | Phenyltolyl Ether | 189 | N.D. | 383 |
| | 3 | CBOC | Ethylene Glycol | 147 | N.D. | 356 |
| | | | Diphenyl Ether | | | |
| Reference | 1 | —* | | 145 | 343 | >500 |
| Example | 2 | Terephthalic | Diphenyl Ether | 142 | 381 | >500 |
| | | Acid | | | | |

*Polyether ether ketone obtained by a nucleophilic substitution reaction using hydroquinone and 4,4′-difluorobenzophenone as monomers.

Where a numerical limit or range is stated herein, the endpoints are included. Also, all values and subranges within a numerical limit or range are specifically included as if explicitly written out.

The singular forms “a,” “an,” and “the” include plural referents unless the context clearly dictates otherwise. Thus, for example, reference to “a substituent” includes reference to one or more substituents.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A polyether ketone compound obtained by reacting a compound represented by formula (1) below: 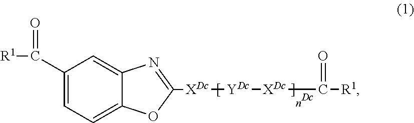
wherein:
R¹ represents a hydroxy group or a halogen atom;
X^{Dc} represents a divalent aromatic group optionally having a substituent, a divalent aliphatic hydrocarbon group optionally having a substituent, or a divalent non-aromatic heterocyclic group optionally having a substituent;
Y^{Dc} represents —O—, —N═N—, a carbonyl group, an alkenylene group optionally having a substituent, or a single bond;
n^{Dc} represents an integer of 0 to 2;
the two R¹ may be the same as or different from each other;
when there are a plurality of X^{Dc}, they may be the same as or different from each other; and
when there are a plurality of Y^{Dc}, they may be the same as or different from each other,
with a compound represented by formula (2) below: 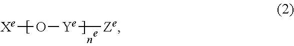
wherein:
X^{e} represents a monovalent aromatic hydrocarbon group optionally having a substituent;
Y^{e} represents a single bond, a divalent aliphatic hydrocarbon group optionally having a substituent, a divalent aromatic group optionally having a substituent, or a divalent non-aromatic heterocyclic group optionally having a substituent;
Z^{e} represents a monovalent aromatic hydrocarbon group optionally having a substituent;
n^{e} represents an integer of 1 to 5; and
when there are a plurality of Y^{e}, they may be the same as or different from each other.

2. The polyether ketone compound according to claim 1, wherein X^{Dc} is a phenylene group optionally having a substituent, a naphthylene group optionally having a substituent, an anthracenylene group optionally having a substituent, a furandiyl group optionally having a substituent, a pyridinediyl group optionally having a substituent, a thiophenediyl group optionally having a substituent, a quinolinediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group containing an oxygen atom as a heteroatom composing a heterocycle and optionally having a substituent.

3. The polyether ketone compound according to claim 1, wherein each of X^{e} and Z^{e} is individually a phenyl group optionally having a substituent or a naphthyl group optionally having a substituent.

4. The polyether ketone compound according to claim 1, wherein Y^{e} is a single bond, an alkylene group optionally having a substituent, a cycloalkylene group optionally having a substituent, a phenylene group optionally having a substituent, a naphthylene group optionally having a substituent, a furandiyl group optionally having a substituent, a pyridinediyl group optionally having a substituent, a thiophenediyl group optionally having a substituent, a quinolinediyl group optionally having a substituent, or a divalent non-aromatic heterocyclic group containing one or more atoms selected from the group consisting of an oxygen atom, a sulfur atom and a nitrogen atom as a heteroatom composing a heterocycle and optionally having a substituent.

5. The polyether ketone compound according to claim 1, wherein n^{Dc} is 0, and X^{Dc} is a phenylene group optionally having a substituent.

6. The polyether ketone compound according to claim 1, wherein, n^{e} is 1 or 2, each of X^{e} and Z^{e} is a phenyl group optionally having a substituent, and Y^{e} is a single bond or an alkylene group having 1 to 6 carbon atoms and optionally having a substituent.

7. The polyether ketone compound according to claim 1, wherein the substituent is selected from the group consisting of a halogen atom, an alkyl group, an alkoxy group, an aryl group, an alkylidene group, an amino group, a phosphino group, a formyl group, an acyl group, a cyano group, a nitro group, a hydroxy group, and an oxo group.

8. The polyether ketone compound according to claim 1, wherein the compound represented by formula (2) is one or more selected from the group consisting of compounds represented by formulae (2-1) to (2-19) below:

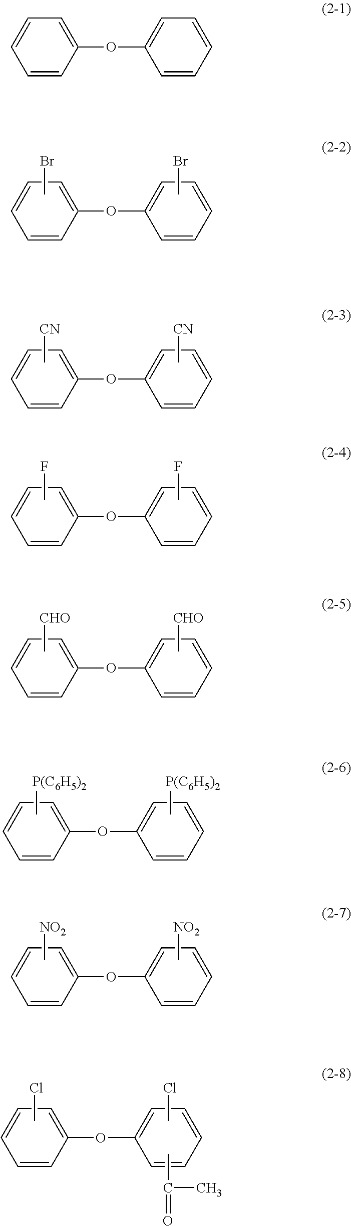

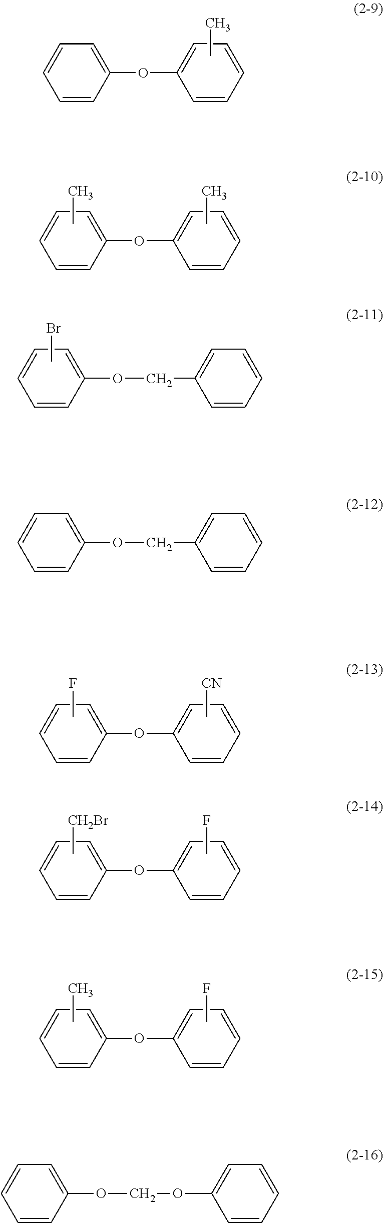

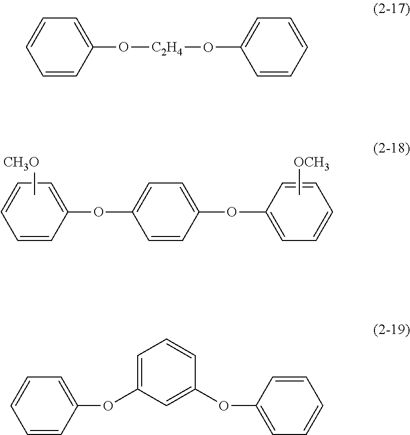

9. The polyether ketone compound according to claim 8, wherein the compound represented by formula (2) is a compound represented by formula (2-1), (2-9), or (2-17).

10. The polyether ketone compound according to claim 1, wherein the polyether ketone compound is obtained by reacting a compound represented by formula (1), a compound represented by the formula (2), and one or more components selected from the group consisting of an aromatic dicarboxylic acid, a salt of an aromatic dicarboxylic acid, an ester of an aromatic dicarboxylic acid, and a halide of an aromatic dicarboxylic acid.

11. The polyether ketone compound according to claim 1, wherein the polyether ketone compound is obtained by a reaction of a compound represented by formula (1) and a compound represented by the formula (2) in a molar ratio of (the compound represented by formula (1))/(the compound represented by formula (2)) of 10/1 to 1/10.

12. The polyether ketone compound according to claim 1, wherein the polyether ketone compound is obtained by a reaction at a temperature of −10 to 200° C.

13. A polyether ketone compound, comprising one or more structural units selected from the group consisting of structural units represented by formulae (i) to (iv): 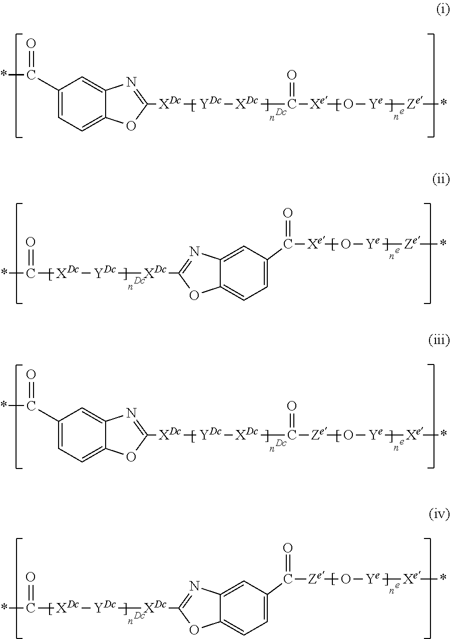
wherein:
X^{Dc} represents a divalent aromatic group optionally having a substituent, a divalent aliphatic hydrocarbon group optionally having a substituent, or a divalent non-aromatic heterocyclic group optionally having a substituent;
Y^{Dc} represents —O—, —N═N—, a carbonyl group, an alkenylene group optionally having a substituent, or a single bond;
n^{Dc} represents an integer of 0 to 2;
X^{e′} represents a divalent aromatic hydrocarbon group optionally having a substituent;
Y^{e} represents a single bond, a divalent aliphatic hydrocarbon group optionally having a substituent, a divalent aromatic group optionally having a substituent, or a divalent non-aromatic heterocyclic group optionally having a substituent;
Z^{e′} represents a divalent aromatic hydrocarbon group optionally having a substituent;
n^{e} represents an integer of 1 to 5, and
* represents a bond;
when there are a plurality of X^{Dc}, they may be the same as or different from each other;
when there are a plurality of Y^{Dc}, they may be the same as or different from each other; and
when there are a plurality of Y^{e}, they may be the same as or different from each other.

14. The polyether ketone compound according to claim 13, which has a glass transition temperature (T_{g}) of 140° C. or higher and 400° C. or lower.

15. The polyether ketone compound according to claim 13, which has a melting point (Tₘ) of 300° C. or higher and 500° C. or lower.

16. The polyether ketone compound according to claim 13, which has a 5% mass reduction temperature (T_{d}) of 300° C. or higher and 500° C. or lower.

17. A method of producing a polyether ketone compound, the method comprising reacting a compound represented by formula (1): 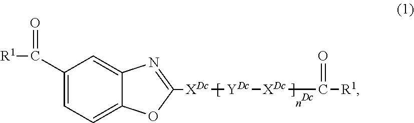
wherein:
R¹ represents a hydroxy group or a halogen atom;
X^{Dc} represents a divalent aromatic group optionally having a substituent, a divalent aliphatic hydrocarbon group optionally having a substituent, or a divalent non-aromatic heterocyclic group optionally having a substituent;
Y^{Dc} represents —O—, —N═N—, a carbonyl group, an alkenylene group optionally having a substituent, or a single bond;
n^{Dc} represents an integer of 0 to 2;
the two R¹ may be the same as or different from each other;
when there are a plurality of X^{Dc}, they may be the same as or different from each other; and
when there are a plurality of Y^{Dc}, they may be the same as or different from each other,
with a compound represented by formula (2): 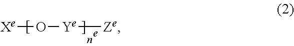
wherein:
X^{e} represents a monovalent aromatic hydrocarbon group optionally having a substituent;
Y^{e} represents a single bond, a divalent aliphatic hydrocarbon group optionally having a substituent, a divalent aromatic group optionally having a substituent, or a divalent non-aromatic heterocyclic group optionally having a substituent;
Z^{e} represents a monovalent aromatic hydrocarbon group optionally having a substituent;
n^{e} represents an integer of 1 to 5; and
when there are a plurality of Y^{e}, they may be the same as or different from each other,
at a molar ratio of (the compound represented by formula (1))/(the compound represented by formula (2)) of 1/10 to 10/1.
